(19) United States
(12) Patent Application Publication
(10) Pub. No.: US 2023/0402593 A1
(43) Pub. Date: Dec. 14, 2023

(54) DEVICE AND METHOD FOR UTILIZING INTERCALATION ZINC OXIDE WITH AN ELECTRODE

(71) Applicant: RESEARCH FOUNDATION OF THE CITY UNIVERSITY OF NEW YORK, New York, NY (US)

(72) Inventors: Brendan HAWKINS, New York, NY (US); Damon TURNEY, New York, NY (US); Sanjoy BANERJEE, New York, NY (US)

(21) Appl. No.: 18/035,213

(22) PCT Filed: Nov. 3, 2021
(86) PCT No.: PCT/US2021/057920

§ 371 Date: May 3, 2023

Related U.S. Application Data
(60) Provisional application No. 63/109,087, filed on Nov. 3, 2020.

(51) Int. Cl. H01M 4/48; H01M 10/48; H01M 4/24; H01G 11/46; H01G 11/28; C01G 9/02

(52) U.S. Cl. CPC H01M 4/48; H01M 10/48; H01M 4/244; H01G 11/46; H01G 11/28; C01G 9/02; G01J 3/46

(57) ABSTRACT

A system for utilizing zinc oxide includes a first electrode comprising a zinc oxide reagent material, a current collector electrically connected to the zinc oxide reagent material, and a second electrode. The zinc oxide reagent material is capable of electrochemical intercalation and de-intercalation reactions with an electrolyte, and the zinc oxide reagent material comprises a zinc oxide intercalated with electrons. The current collector is configured to provide electrons and voltage control to the zinc oxide reagent material. The electrolyte in contact with the zinc oxide reagent material and is capable of executing intercalation reactions with the zinc oxide reagent material. The electronics are configured to control electrochemical voltage of the current collector and the zinc oxide reagent material, and the second electrode comprises a counter-electrode or a reference electrode electrically coupled to one or more electronics.

### CROSS-REFERENCE TO RELATED APPLICATIONS

This application claims priority to U.S. Provisional Application No. 63/109,087 filed Nov. 3, 2020 and entitled “DEVICE AND METHOD FOR UTILIZING INTERCALATION ZINC OXIDE WITH AN ELECTRODE”, the entirety of which is incorporated herein by reference.

### STATEMENT REGARDING FEDERALLY FUNDED RESEARCH OR DEVELOPMENT

This invention was made with government support under grant numbers DE-NA0003525 and DE-SC0012704 awarded by the United States Department of Energy. The government has certain rights in the invention.

### BACKGROUND

Electrochemical energy storage systems are commonly used for grid-scale and building-scale energy storage systems for applications such as renewable energy storage, peak demand reduction, uninterruptible power supplies, and others. Two electrochemical energy storage systems are batteries and electrochemical capacitors. Batteries provide stable long-term energy storage for covering outages or unmet peak demand in high energy densities for grid-scale or building-scale applications. Electrochemical capacitors provide a fast response to cover power demand intermittency or high frequency, which are unmet by batteries' slow response time.

Accordingly, there exists a need for electrochemical energy storage systems that combine batteries and capacitors because of their ability to meet energy demand on short and long-time scales. Electrochemical capacitors can be installed in battery modules to achieve the goals outlined elsewhere in this disclosure. However, this requires additional space and material which add cost and decrease energy density. Increasing energy density and decreasing cost are of paramount interest for battery applications. Accordingly, there exists a need for inventions that decrease material and manufacturing cost. Accordingly, there exists a need for inventions that decrease battery module size and weight.

Battery performance including cyclability and durability is affected by the electrochemical potentials of the battery electrodes, which are variable during operation of a battery. Battery performance is also affected by the electrical conductivity of the chemical species in the battery electrode including, but not limited to, metals, oxides, and hydroxides. It is often difficult, expensive, or impossible to determine the conductivity of these species in a battery as it is operating. Battery performance is also affected by the passivation of metal species, preventing further discharge of the battery. Passivation is related to electrochemical potential and oxide buildup, but it is often difficult, expensive, or impossible to predict or prevent the passivation of electrodes prior to occurrence.

Some electrochemically active battery materials exhibit a phenomenon called electrochromism, in which the color of the material changes as a function of electrochemical potential. Accordingly, the color of the battery material can be directly related to the electrochemical potential. Additionally, the electrochemical potential of electrochromic materials can affect the electrical conductivity of those materials.

Accordingly, the color of the material can inform material electrical resistance and electrochemical potential. Accordingly, there is a need for devices or processes that can measure the color, electrical conductivity, and electrochemical potential of the materials in battery electrodes. Additionally, there is a need for systems that can use this information to regulate battery cycling protocol to improve performance.

Energy consumption for indoor spaces can be reduced through the use of transparency-changing windows. Electrochromic windows change color through alteration of electrochemical potential of an electrochromic material. Color-changing and transparency-changing electrochromic glazing systems have also been used on automobiles, mirrors, displays, glasses, and other devices to improve performance by providing benefits such as reducing glare. The materials comprising these devices must be low-cost in order to enable wide-spread commercialization. Accordingly, there is a need for earth-abundant and low-cost electrochromic materials.

### SUMMARY

This disclosure allows greater power supply to/from a battery for short time periods. The battery is useful for applications where high power for short time scales is needed in addition to lower power for longer time scales. The public electricity grid is an example marketplace for such services. This battery reduces material and labor costs and increases battery-capacitor module energy density.

The battery uses sensors, such as auxiliary reference electrodes, light sensors, or other to measure the color, conductivity, or electrochemical potential of a metal oxide in a battery electrode. This information is supplied to a battery management system (BMS) to inform cycling protocol and provide an assessment of electrode heath and state of charge. The disclosure improves cyclability and durability of batteries through informed management of cycling protocol.

The disclosure includes an electrochromic device comprising an electrochromic material on a current collector, a counter electrode, and an ionically conductive and electrically insulating separator between the electrochromic material and the counter electrode. The battery uses zinc oxide (ZnO) as the active color-changing or transparency-changing electrochromic material in an electrochromic device.

In some embodiments, a system for utilizing zinc oxide includes a first electrode comprising a zinc oxide reagent material; a current collector electrically connected to the zinc oxide reagent material, and a second electrode. The zinc oxide reagent material is capable of electrochemical intercalation and de-intercalation reactions with an electrolyte, and the zinc oxide reagent material comprises a zinc oxide intercalated with electrons. The current collector is configured to provide electrons and voltage control to the zinc oxide reagent material. The electrolyte in contact with the zinc oxide reagent material and is capable of executing intercalation reactions with the zinc oxide reagent material. The electronics are configured to control electrochemical voltage of the current collector and the zinc oxide reagent material, and the second electrode comprises a counter-electrode or a reference electrode electrically coupled to one or more electronics.

In some embodiments, a method for utilizing zinc oxide comprises changing an electrochemical voltage of a zinc oxide material that hosts intercalation reactions, and extracting an electrical current from the zinc oxide material as part of a battery operation or a pseudo-capacitor operation.

In some embodiments, a method for utilizing zinc oxide comprises extracting information regarding color or conductivity from zinc oxide via a sensor, and controlling an electrochemical voltage of the electrode in a battery or pseudo-capacitor using the information. The zinc oxide is part of an electrode, and the zinc oxide is intercalated with at least one additional element.

In some embodiments, a method for generating intercalation zinc oxide comprises converting zinc metal to zinc oxide intercalated with at least one additional element to produce a zinc oxide reagent material, and placing the zinc oxide reagent material into a battery.

In some embodiments, a method for generating intercalation zinc oxide comprises converting zinc metal to zinc oxide intercalated with an additional element in situ in a device.

In some embodiments, a battery comprises an anode, a cathode, a separator disposed between the anode and the cathode, and an electrolyte in fluid communication with the anode, the cathode, and the separator. The separator comprises at least one ion selective layer, and the anode comprises a zinc oxide reagent material comprising a zinc oxide intercalated with electrons.

These and other features will be more clearly understood from the following detailed description taken in conjunction with the accompanying drawings and claims.

### BRIEF DESCRIPTION OF THE DRAWINGS

The drawings aid the explanation and understanding the invention. Since it is not usually possible to illustrate every possible embodiment, the drawings depict only example embodiments. The drawings are not intended to limit the scope of the invention. Other embodiments may fall within the scope of the disclosure and claims.

FIG. 1 illustrates electrochemical data of a ZnO electrochemical capacitor accompanying a step change in electrode potential from 0.25 to 0.1 V vs. Zn/Zn²⁺.

FIG. 2 illustrates the electrical resistance of ZnO as a function of electronic potential vs. Zn/Zn2+.

FIG. 3 illustrates the potential of a Zn electrode with ZnO vs. time.

FIG. 4 illustrates the RGB color values of the electrode and the electrical resistance of the ZnO vs. time.

FIG. 5 shows current change in response to step changes in voltage indicating charge insertion/disinsertion in response to voltage.

FIG. 6 shows the color of the window (red, green, and blue curves) as a function of time. Color and transparency of the ZnO material changes as a function of voltage, the proof of concept of a ZnO-based electrochromic layer for color-changing and transparency-changing devices.

FIG. 7A shows visible light photographs taken during galvanostatic discharge of Zn foil.

FIG. 7B shows cyclic voltammetry (1 mV/s) on Zn foil and ZnO on Zn foil with visible light photographs for bare Zn foil (i, ii) and ZnO on Zn foil (iii, iv) at 0.05 V and 1 V, respectively.

FIG. 7C shows electrochromic ZnO capacity measurements.

FIG. 7D shows cyclability assessment: chronopotentiometry of electrochromic ZnO on Zn foil for selected cycles 100, 15,000, and 35,000.

FIG. 7E shows visible light photographs of ZnO on Zn foil at (i) 0.05 V, cycle 100, (ii) 0.05 V, cycle 15,000, (iii) 0.05 V, cycle 35,000, (iv) 1.0 V (cycle 100), (v) 1.0V (cycle 15,000), and (vi) 1.0 V (cycle 35,000). Scale bar: 0.5 mm.

FIG. 8 shows a cross sectional view of an embodiment of a battery.

FIGS. 9A-9D show in operando UV-vis spectroscopy with FIG. 9A showing visible light photographs of ZnO at different potentials, FIG. 9B showing schematic of UV-vis setup, FIG. 9C showing electrochromic ZnO absorption coefficients, and FIG. 9D showing Tauc plot for band gap estimation.

FIGS. 10A and 10B show in operando electrochemical impedance spectroscopy (EIS) with FIG. 10A showing Nyquist plot of EIS data (150 kHz to 1 Hz) and model fits (inset: model), and FIG. 10B showing ZnO resistance calculations from model.

FIGS. 11A-11C show in operando synchrotron XRD, with FIG. 11A showing Schematic and visible light photographs of electrochromic and amber ZnO on Zn foil, (b) synchrotron XRD patterns with ZnO reflections indicated, (c) d-spacing of (002) ZnO reflection as a function of electrode potential (inset: schematic of ZnO lattice contraction).

FIGS. 12A-12F shows in operando confocal Raman spectroscopy with FIG. 12A showing visible light photograph and schematic of electrochromic and amber ZnO (Raman spectra stimulation by 532 nm light unless noted otherwise), FIG. 12B showing electrochromic and amber ZnO at 0.0 V and 1.0 V, FIG. 12C showing electrochromic ZnO at 1.0 V, 0.6 V, 0.3 V, and 0.0 V, FIG. 12D showing electrochromic ZnO at 0.0 V and 1.0 V stimulated by 532 nm and 633 nm light, FIG. 12E showing electrochromic ZnO in KOH, NaOH, and KOH electrolyte made with D₂O, and FIG. 12F showing energy level diagram for V_{O} in ZnO.

FIGS. 13A-13F show the results of galvanostatic discharge of a Zn-alkaline battery with in operando optical microscopy and testing of a ZnO-based electrochromic window, with FIG. 13A showing visible light photographs taken in operando of Zn, cellophane separator, and MnO₂, scale bar 0.25 mm, at (i) start of discharge, (ii) just before formation of ZnO, (iii) after formation of blue ZnO, and (iv) during passivation of Zn electrode, FIG. 13B showing Zn paste electrode potential vs. Zn reference with associated current to MnO₂, FIG. 13C showing relative RGB color values (red, green, and blue curves) from in operando imaging of Zn electrode and relative ZnO resistance (black curve) vs. Zn equilibrium, estimated by linear interpolation of EIS data, FIG. 13D showing visible light images of electrochromic window at (i) −0.1 V and (ii) 1.1 V vs. Zn counter electrode, FIG. 13E showing potentiostatic cycling of ZnO window vs. Zn counter electrode with voltage and current response, and FIG. 13F showing relative RGB color values (red, green, and blue curves) taken from an electrochromic window.

FIGS. 14A-14D show the construction and images of a Zn foil electrode with FIG. 14A showing a schematic of electrode before ZnO generation, FIG. 14B showing associated visible light photograph, FIG. 14C showing schematic of electrode after ZnO generation, and FIG. 14D showing associated visible light photograph.

FIG. 15 shows another schematic of completed Zn foil electrochemical cell.

FIG. 16 illustrates the discharge capacity of Zn foil during generation of ZnO via chronoamperometry at 0.2 V.

FIG. 17 shows a visible light photograph of accumulated ZnO for capacity calculation (scale bar 0.5 mm).

FIG. 18 shows the chronoamperometry voltage steps and current for ZnO capacity calculation.

FIG. 19 shows the capacity from chronoamperometry (step from 0.25 V to 0.1 V at 300 seconds).

FIG. 20 shows the capacity of ZnO for coloration efficiency with the voltage stepped between 0.05 V and 1 V.

FIG. 21 shows a photograph of EIS setup at 0 V with distance between EIS measurement cables.

FIG. 22 illustrates a schematic of EIS setup according to an embodiment.

FIG. 23 illustrates the Raman data acquired on electrochromic ZnO held at a potential of 0 V in H₂O- and D₂O-based KOH electrolytes.

FIG. 24 illustrates the electrochromic ZnO diffractogram and standard reference data.

FIG. 25 illustrates the crystallographic d-spacing of (100) XRD reflection vs. electrode potential.

FIG. 26 illustrates the crystallographic d-spacing of (101) XRD reflection vs. electrode potential.

FIG. 27 illustrates the molecular structure of TBPOH.

FIGS. 28A-28D show visible light photographs of color change of ZnO generated in 1.4 M TBPOH in H₂O with FIG. 28A taken at (a) 0.05 V, FIG. 28B taken at 1.0 V, and photographs with color screen showing only pixels with blue coloration shown in FIG. 28C taken at 0.05 V and FIG. 28D taken at 1.0 V.

FIGS. 29A-29D show visible light photographs of color change in 1.4 M TBPOH in H₂O of ZnO generated in KOH with FIG. 29A showing a photograph taken at 0.05 V, FIG. 29B showing a photograph taken at 0.3 V, FIG. 29C showing a photograph taken at 0.5 V, and FIG. 29D showing a photograph taken at 1.0 V. The scale bar for all photographs is 0.5 mm.

FIG. 30 illustrates an SEM image of a ZnO urchin structure, ˜35,000× magnification, scale bar: 10 μm.

FIG. 31 illustrates an SEM image of a ZnO urchin structure, ˜150,000× magnification, scale bar: 2 μm.

FIG. 32 illustrates a TEM image of a ZnO needle structure.

FIG. 33 illustrates a TEM image of a lattice fringe on a ZnO needle.

FIGS. 34A-34B illustrate EDS results from blue electrochromic ZnO washed with deionized water with FIG. 34A showing X-ray emission counts and associated atomic identity. Arrow indicates position of characteristic potassium emissions. Inset: elemental composition calculated by EDAX EDS. FIG. 34B shows an SEM image of area analyzed. Crosshairs indicate exact location.

FIG. 35 illustrates the XPS results of three ZnO samples: Unwashed blue-colored electrochromic ZnO (top line with peak), washed blue-colored electrochromic ZnO (middle line), and commercially purchased ZnO (bottom line).

### DETAILED DESCRIPTION

Disclosed herein is a metal oxide material having another element intercalated therein. In some aspects, the metal oxide is a zinc oxide, and the inclusion of another material can allow the properties of the zinc oxide to be modified. In some aspects, a zinc oxide having another element intercalated therein can be referred to as a zinc oxide reagent material for purposes of this description. For example, a color and/or capacity of the zinc oxide reagent material can be modified, which can allow the capacity or state of charge to be determined during use. In some aspects, the ability to modify the color of the material may allow the material to be used for a color changing window or material that can find use in a variety of devices.

In some aspects, the material can be used in a battery. Accordingly, this disclosure proves a battery material such as a metal or metal oxide and an electrochemical capacitor material which is an electrochemically oxidized or reduced version of the battery material. The electrochemical capacitor material can be mixed or combined with the battery electrochemical material in order to provide two different active materials. The disclosure allows for control of the proportions of battery and capacitor material through partial oxidation or reduction of the electrode.

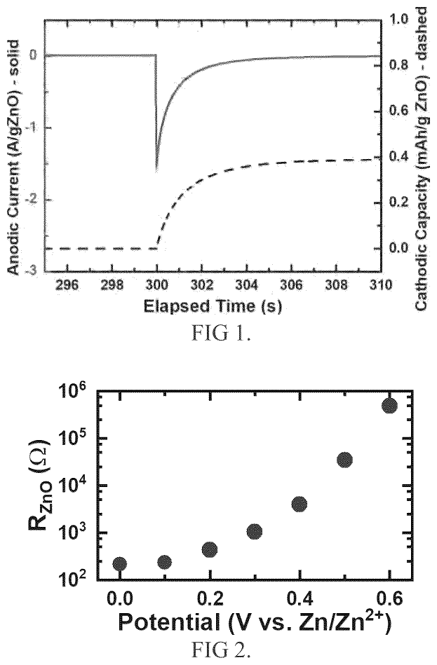

The electrochemical capacitor material can provide high discharge rates for short time periods. The battery material can provide lower discharge rates for long time periods. The electrochemical capacitor material can be in electrical contact with the current collector of the battery. The electrochemical capacitor material can deliver its capacity in a few seconds, as shown in FIG. 1, which shows the capacity and current response of zinc oxide (ZnO) in a zinc metal (Zn) battery electrode over a voltage step from 0.25 V to 0.1V vs. a Zn reference. The full capacity of the ZnO is accessed in ˜5 seconds, and the full capacity over a (0.6 V range) of the electrode is ˜1 mAh. The electrochemical capacity and response time are similar to those of currently used commercial electrochemical capacitor materials. While described in various examples as using Zn and ZnO, these are provided solely for illustrative purposes and are not intended to be limiting. More specifically, other materials as described herein may also be used to provide the properties as described herein. In some aspects, the electrochemical capacitor material may or may not be fabricated in such a way as to maximize the electrical contact of the electrochemical capacitor material with the battery electrochemical material or with the current collector.

When used in a battery, the battery can use sensors, such as auxiliary reference electrodes or light sensors, to measure the electrochemical potential of a metal oxide in a battery electrode. The battery can uses light sensors to measure electrical conductivity of a material based on an observed color change of the material. The electrochemical potential or conductivity can be provided to a battery management system (BMS) to inform cycling protocol(s) and provide an assessment of electrode heath and state of charge. An algorithm to determine the conductivity of zinc oxide can be used as shown, for example, according to the follow data in FIG. 2. Zinc oxide is provided solely for illustrative purposes and is not intended to be limiting.

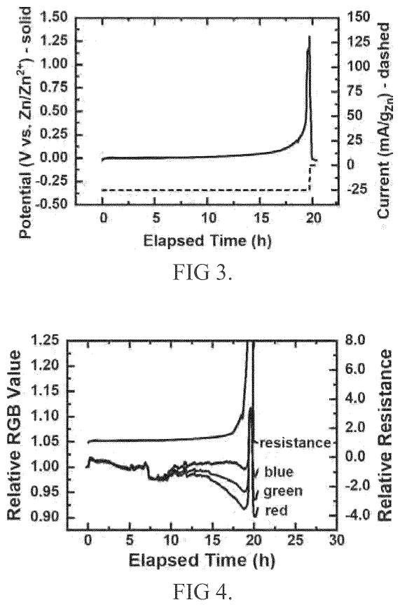

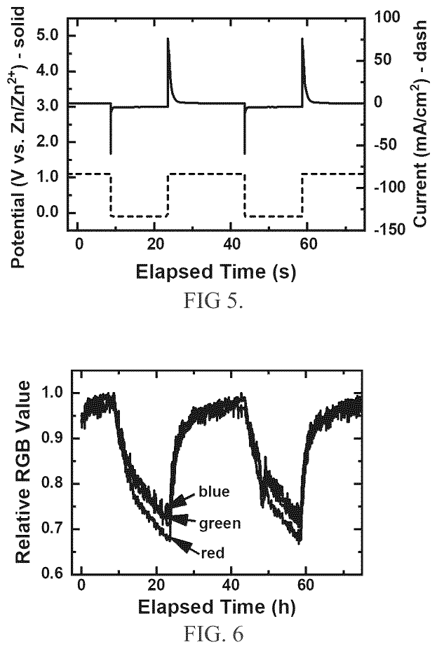

FIG. 3 shows electrode potential of a Zn paste electrode with accumulated ZnO, in which potential increases after oxide buildup. FIG. 4 shows the color values of in operando images of the electrode (red, green, and blue curves) and the electrical resistance of the oxide as a function of time. Color and resistance vary together a function of electrode potential. Measuring potential with an auxiliary electrode or color with an optical device allows determination of the electrical resistance of the oxide. This information can be provided to the BMS to improve cycling protocol.

In some aspects, the battery can use ZnO as an active electrochromic material in a device. An electrochromic device is any device that requires a color-changing or transparency-changing material, in which color-change or transparency-change is achieved through an electrochemical reaction. In ZnO, coloration is achieved through the insertion of electrons into the material accompanied by the insertion or disinsertion of some charge-compensating ion, whereas discoloration is achieved through the disinsertion of electrons. The insertion/disinsertion of electrons is controlled by the electrochemical potential.

In some aspects, sensors, such as auxiliary reference electrodes, light sensors, or other sensors can be used to measure the color, conductivity, or electrochemical potential of a metal oxide in a battery electrode. The disclosed battery can supply this information to a battery management system (BMS) to inform cycling protocol and provide an assessment of electrode heath and state of charge. The battery can improve cyclability and durability of batteries through informed management of cycling protocol.

In some embodiments, a battery can comprise an electrochromic device comprising an electrochromic material on a current collector, a counter electrode, and an ionically conductive and electrically insulating separator between the electrochromicmaterial and the counter electrode. The battery can use zinc oxide (ZnO) as the active color-changing or transparency-changing electrochromic material in an electrochromic device. The battery may use other electrochromic materials in addition to ZnO in the device.

In various aspects, this disclosure relates to electrochemical energy storage. This disclosure provides a method for generating an electrochemical capacitor in situ in a battery electrode. This disclosure provides a method of creating a hybrid battery-capacitor electrode through oxidation or reduction of a battery electrode. This disclosure provides a method of meeting power demands on short time scales with an electrochemical capacitor material and on long time scales with a battery electrode material in one self-contained electrode.

This disclosure provides a method for measuring electrochemical potential of a battery electrode. This disclosure provides a method for measuring electrical conductivity of electrochemically active materials. This disclosure provides a method improving battery cyclability and durability. This disclosure provides a method for informing battery cycling protocol through means of a battery management system.

In some aspects, this disclosure relates to electrochemically color-changing or transparency-changing materials, i.e. electrochromic materials. This disclosure relates to windows that can change color or transparency to reduce building energy consumption, sometimes called “smart” windows. This disclosure relates to color-changing or transparency-changing coatings on glass, glasses, mirrors, displays, or other materials or devices to improve performance of said material or device. This disclosure relates to any other application of electrochromic materials.

As discussed above, various metal oxides can be used to provide electrochromic materials that can be used in batteries, capacitors, and other types of devices. One such compound is zinc oxide. Zinc oxide (ZnO) is of great interest for a wide array of next-generation electronic devices, however, progress developing ZnO-based devices has been slow due to poor control and understanding of electronic properties via the underlying defect structure. As disclosed herein, reversible control of the defect structure and electronic structure of ZnO in alkaline solutions can be achieved through reversible transfer of electrons into the zinc oxide. It has been discovered that approximately 40 μmol of electrons per g-ZnO can be inserted into the zinc oxide structure along with a charge-compensating amount of H⁺ or O²⁻ in a 0.6 V potential range. This leads to control of the bandgap width, to electrical resistance switching of over ˜1,000×, and to electrochromic absorbance changes of ˜1,000×. The resulting material can be used zinc-alkaline batteries and/or electrochromic windows. Introduction

Zinc oxide (ZnO) is under study for many applications in the next-generation clean-technology ecosystem such as (i) low-cost aqueous batteries, (ii) transparent front-contacts on thin-film solar cells and electrochromic windows, (iii) semiconductor lighting and switching, (iv) chemical sensors, and (v) hydrogen catalysts. However, the successful use of ZnO in these applications has been hindered by difficulty controlling ZnO defects and by an incomplete understanding of the connections between material properties and underlying defects. Thus, key capabilities, such as p-type doping and long-term durability of conductivity and optical properties, are unreliable. Further development of ZnO technology requires improved physical understanding and better control of ZnO defects, which include native zinc or oxygen defects, and unavoidable hydrogen impurities.

Disclosed herein are methods and systems that allow for electrochemical control of the bandgap width, bulk conductivity, and visible absorbance of wurtzite ZnO, constituting the first report of electrochromism in a native crystal structure of ZnO. Previous literature reports electrochromism in ZnO only if copious lithium is inserted (i.e., more than 5×10²² cm³ (1.0 mole ratio)) which causes drastic change to the crystal structure. As described herein, the disclosed materials can operate with impurity concentrations on the order 10¹⁹ per cm³ (0.001 mole ratio) in otherwise native wurtzite ZnO. The material can be characterized with facile in operando experimental methods that provide insights into ZnO defect and electronic structure. The greater impacts of this discovery are the identification of a novel electrochromic material with good energy efficiency and the immediate application of switchable ZnO electronic properties in zinc alkaline batteries and transparency-switched electrochromic windows. Other promising applications exist in solar panel transparent front contacts and resistor-based memory.

The synthesis methods for these nanocrystal dispersions creates an electrochemically active ZnO that accommodates insertion of electrons and cations M^{y+} via a chemical or photochemical redox reaction with the surrounding electrolyte (Equation 1),

xM^{y+}+xye⁻+ZnO_{colorless}↔MₓZnO_{blue} (Eq. 1)

changing the ZnO color from white to blue as this reaction proceeds, which is classic electrochromism. As shown, the resulting zinc oxide reagent material can have various cations inserted into the crystal structure, including, but not limited to, cations of H, Li, Na, K, Cs, Al, In, Mg, Ca, or any combination thereof.

The zinc oxide reagent materials provided herein can be formed through the oxidation of Zn metal in an alkaline environment such as in the presence of an alkaline electrolyte. Oxidation first causes surface layers of Zn to dissolve and form zincate ions, Zn(OH)42− (Eqn. 2) and later forms a layer of solid ZnO on the Zn metal via either precipitation of zincate ions (Eqn. 3) or direct solid-state discharge of the Zn metal (Eqn. 4).

Zn+4OH⁻↔2e⁻+Zn(OH)₄²⁻ (Eq. 2)

Zn(OH)₄²⁻↔ZnO+H₂O+2OH⁻ (Eq. 3)

Zn+2OH⁻↔2e⁻+ZnO+H₂O (Eq. 4)

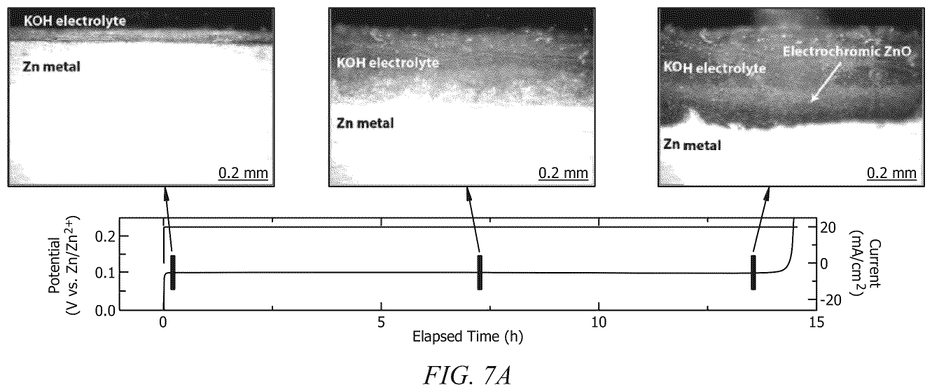

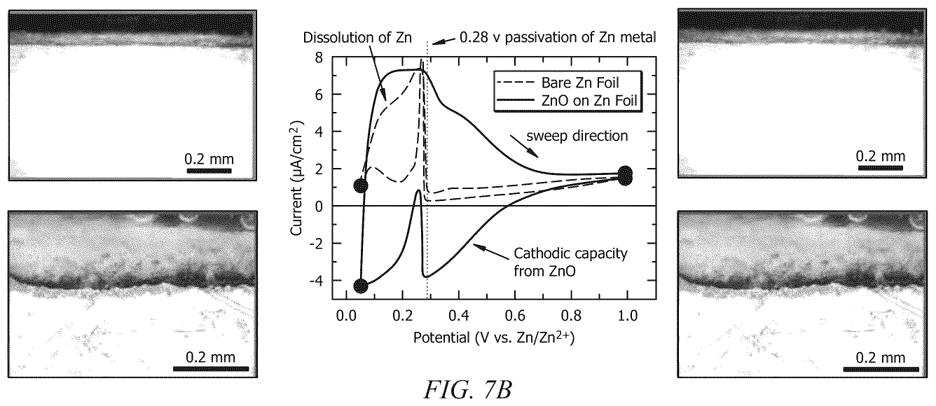

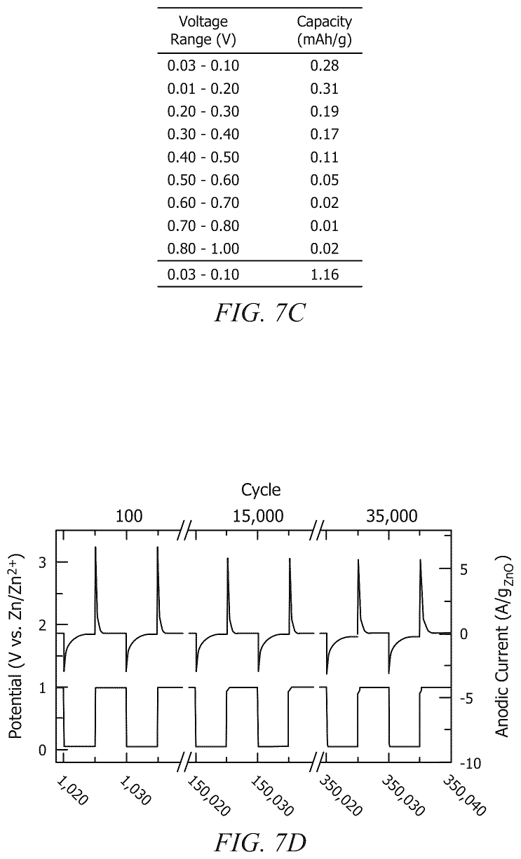

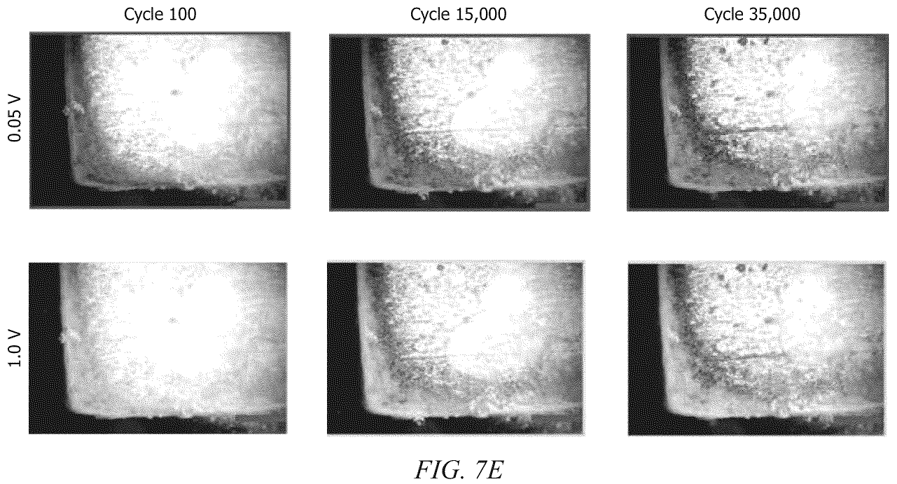

The above-described process of ZnO formation in alkaline electrolyte is shown by in operando optical microscopy in FIG. 7A. The data also illustrates that when electrode potential is negative, ZnO converts back to Zn. Consequently, the electrode potential can be maintained above 0.02 V during ZnO characterization (where all voltages provided are relative to Zn metal equilibrium, Zn/Zn²⁺).

The ZnO, as characterized by operando X-ray diffraction (XRD) and confocal Raman spectroscopy in the Examples provided herein, can be generated via oxidation of Zn, and is apparent in FIG. 7a(iii) as a dark blue layer above the Zn electrode. The color is notable because ZnO is typically white in appearance. Simultaneous in operando visible light imaging and cyclic voltammetry (FIG. 7b) reveals the same ZnO reversibly changes color from white at 0.60 V gradually to blue at ˜0.05 V. The timescale of this color change is approximately a few seconds. Accompanying coloration is insertion of 1 electron per 300 ZnO units, corresponding to a total charge transfer Q of approximately 1 mAh g⁻¹ (FIG. 7c). The wurtzite ZnO structure can be maintained throughout this process. The reversible color-change is most evident in visible light photography (FIG. 7d) Cycling the ZnO between 0.05 V and 1.0 V verifies this phenomenon is repeatable for tens of thousands of cycles with no visible evidence of ZnO deterioration or reduction in color change dynamics (FIG. 7e). This simultaneous charge transfer and color change behavior demonstrates electrochromism. This material can be referred to in some contexts as “electrochromic ZnO”.

There is a reliable correlation between the color of the ZnO and material properties such as conductivity, bandgap width, UV-visible light absorption, and Raman spectra. This can allow for a determination of the conductivity or other material properties of the material using the color of the zinc oxide reagent material as an indicator of the material properties. When used in a battery, the material properties can be used as an indicator of in situ battery properties during operation of the battery, allowing for a relatively easy way to monitor the battery and/or electrodes during use.

In some aspects, a sensor can be used to determine the properties of the battery using light absorbance of the material. For example, the color change can be monitored using various visible observance techniques such as ultraviolet-visible spectroscopy. In some aspects light can be reflected off of the material and detected by a detector at one or more wavelengths to allow for a determination of the properties of the material such as the electric potential of the material.

During this process, an optical absorption coefficient can be measured to determine a color or an indication of the color of the material. In some aspects, the optical absorption coefficient α can vary and rise by a factor of more than 100, more than 500, or about 1,000× as electric potential is decreased from 0.60 to 0.02 V. The material is generally more absorptive to red wavelengths than to blue wavelengths when the potential is ˜0.0 V, resulting in blue coloration. Combining the colorimetry data with the charge transferred, Q, and electrode area, A, allows a calculation of a coloration efficiency (CE) via Eqn. 5, of ˜50 cm²/C, which is similar to other high-efficiency electrochromic materials, suggesting ZnO could be used in low-energy electrochromic devices.

$$CE = \frac{α t}{Q / A} \qquad ( Eq . 5 )$$

The UV-vis data and K-M analysis also allow calculation of the band gap, where the band gap is a function of a and the energy quanta of light absorbed, hv. When the ZnO is held at 0.6 V or higher, its band gap can be measured to be 3.38 eV, which is close to the literature consensus of 3.37 eV. Decreasing the potential to 0.02 V results in a band gap increase to 3.65 eV. This increase is likely a result of the Burstein-Moss effect, in which the rising Fermi level causes an increase in the transition energy required to promote an electron from below the bandgap to empty states.

The electrical resistance of the electrochromic ZnO material can decrease as the material colors blue. While not well understood, this phenomena is believed to occur based on electrons physically inserting into the ZnO structure and without Zn metal being formed. The sensitivity of electrochromic ZnO conductivity to electrochemical potential is important for the performance of Zn battery electrodes, which are influenced greatly from “passivation”, i.e., loss of electrical connectivity between particles.

During coloration of ZnO, electron insertion must be accompanied by cation insertion or anion disinsertion to maintain charge neutrality. Available cations in ZnO-saturated alkaline electrolyte such as sodium hydroxide (NaOH) or KOH alkaline electrolytes are Zn²⁺, H⁺ and either Na⁺ or K⁺, depending on the hydroxide salt used. The available anions are O²⁻ and HO⁻, which both generate V_{O} upon disinsertion. This is consistent with H⁺ insertion or V_{O} generation. This suggests two possible half electrode reactions. As potential is taken from 1.0 V to 0.01 V, there is either a simultaneous insertion of electrons and H⁺ (Eqn. 6), a simultaneous insertion of electrons and generation of V_{O} (Eqn. 7), ora combination of the two.

Colorless H Colored

ZnO₁₋ₓ+yH₂O+ye⁻HH_{y}ZnO₁₋ₓ+yOH⁻ (Eq. 6)

ZnO₁₋ₓ+yH₂O+2ye⁻HZnO_{1-x-y}+2yOH⁻ (Eq. 7)

In some aspects, the zinc oxide reagent material described herein can be used in a battery. The battery can be a primary battery or a secondary batter. Reference to the term “primary battery” (e.g., “primary battery,” “primary electrochemical cell,” or “primary cell”), refers to a cell or battery that after a single discharge is disposed of and replaced. Reference to the term “secondary battery” (e.g., “secondary battery,” “secondary electrochemical cell,” or “secondary cell”), refers to a cell or battery that can be recharged one or more times and reused.

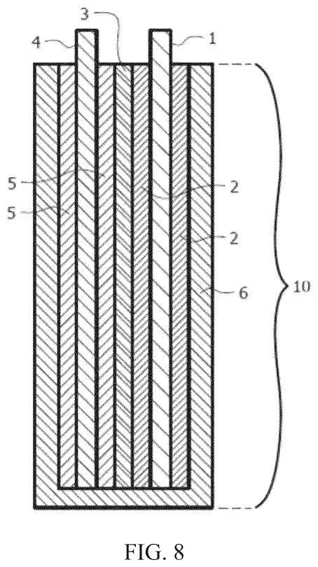

FIG. 8 illustrates a cross sectional view of an embodiment of a battery. Referring to FIG. 8, a battery 10 has a housing 6, a cathode current collector 1, a cathode material 2, a separator 3, an anode current collector 4, and an anode material 5. FIG. 8 shows a prismatic battery arrangement. In another embodiment, the battery can be a cylindrical battery. An electrolyte can be dispersed in an open space throughout battery 10. The cathode current collector 1 and cathode material 2 are collectively called either the cathode or the positive electrode. Similarly, the anode current collector 4 and the anode material 5 are collectively called either the anode or the negative electrode.

The cathode can comprise a mixture of components including an electrochemically active material, a binder, a conductive material, and one or more additional components that can serve to improve the lifespan, rechargeability, and electrochemical properties of the cathode. In some embodiments, the cathode can comprise an ion selective material, including any of those described herein. The cathode can be incorporated into the battery 10 which may be a secondary battery. The active cathode material can based on one or many polymorphs of MnO₂, including electrolytic (EMD), α-MnO₂, β-MnO₂, γ-MnO₂, δ-MnO₂, ε-MnO₂, or λ-MnO₂. Other forms of MnO₂ can also be present such as pyrolusite, ramsdellite, nsutite, manganese oxyhydroxide (MnOOH), α-MnOOH, γ-MnOOH, β-MnOOH, manganese hydroxide [Mn(OH)₂], partially or fully protonated manganese dioxide, Mn₃O₄, Mn₂O₃, bixbyite, MnO, lithiated manganese dioxide, zinc manganese dioxide. Other active components can be present in place of or in addition to MnO₂ such as nickel, nickel oxyhydroxide, nickel hydroxide, silver, silver oxide, copper, copper hydroxide, lead, lead hydroxide, lead oxide, and a combination thereof. In general, the cycled form of manganese dioxide in the cathode is can have a layered configuration, which in some embodiment can comprise δ-MnO₂ that is interchangeably referred to as birnessite. If non-birnessite polymorphic forms of manganese dioxide are used, these can be converted to birnessite in-situ by one or more conditioning cycles as described in more details below. For example, a full or partial discharge to the end of the MnO₂ second electron stage (e.g., between about 20% to about 100% of the 2^{nd} electron capacity of the cathode) may be performed and subsequently recharging back to its Mn⁴⁺ state, resulting in birnessite-phase manganese dioxide.

The addition of a conductive additive such as conductive carbon enables high loadings of MnO₂ in the mixed material, resulting in high volumetric and gravimetric energy density. The conductive carbon can be present in a concentration between about 1-30 wt %. Such conductive carbon include single walled carbon nanotubes, multiwalled carbon nanotubes, graphene, carbon blacks of various surface areas, and others that have specifically very high surface area and conductivity. Higher loadings of the MnO₂ in the mixed material electrode are, in some embodiments, desirable to increase the energy density. Other examples of conductive carbon include TIMREX Primary Synthetic Graphite (all types), TIMREX Natural Flake Graphite (all types), TIMREX MB, MK, MX, KC, B, LB Grades (examples, KS15, KS44, KC44, MB15, MB25, MK15, MK25, MK44, MX15, MX25, BNB90, LB family) TIMREX Dispersions; ENASCO 150G, 210G, 250G, 260G, 350G, 150P, 250P; SUPER P, SUPER P Li, carbon black (examples include Ketjenblack EC-300J, Ketjenblack EC-600JD, Ketjenblack EC-600JD powder), acetylene black, carbon nanotubes (single or multi-walled), carbon nanotubes plated with metal like nickel and/or copper, graphene, graphyne, graphene oxide, Zenyatta graphite, and combinations thereof. The birnessite discharge reaction comprises a dissolution-precipitation reaction where Mn³⁺ ions become soluble and precipitate out on the conductive carbon as Mn²⁺. This second electron process involves the formation of a non-conductive manganese hydroxide [Mn(OH)₂] layer on the conductive graphite.

The addition of a conductive component such as metal additives to the mixed material cathode may be accomplished by addition of one or more metal powders such as nickel powder to the cathode mixture. The conductive metal component can be present in a concentration of between about 0-30 wt %. The conductive metal component may be, for example, nickel, copper, silver, gold, tin, cobalt, antimony, brass, bronze, aluminum, calcium, iron or platinum. In one embodiment, the conductive metal component is a powder. In one embodiment, a second conductive metal component is added to act as a supportive conductive backbone for the first and second electron reactions to take place. The second electron reaction has a dissolution-precipitation reaction where Mn′ ions become soluble in the electrolyte and precipitate out on the graphite resulting in an electrochemical reaction and the formation of manganese hydroxide [Mn(OH)₂] which is non-conductive. This ultimately results in a capacity fade in subsequent cycles. Suitable second component include transition metals like Ni, Co, Fe, Ti and metals like Ag, Au, Al, Ca. Salts or such metals are also suitable. Transition metals like Co also help in reducing the solubility of Mn′ ions. Such conductive metal components may be incorporated into the electrode by chemical means or by physical means (e.g. ball milling, mortar/pestle, spex mixture). An example of such an electrode comprises 5-95% birnessite, 5-95% conductive carbon, 0-50% second conductive metal component and 1-10% binder.

In some embodiments a binder can be used. The binder can be present in a concentration of between about 0-10 wt %. In some embodiments, the binder comprises water-soluble cellulose-based hydrogels, which were used as thickeners and strong binders, and have been cross-linked with good mechanical strength and with conductive polymers. The binder may also be a cellulose film sold as cellophane. The binders were made by physically cross-linking the water-soluble cellulose-based hydrogels with a polymer through repeated cooling and thawing cycles. In one embodiment, wt. % carboxymethyl cellulose (CMC) solution was cross-linked with 0-10 wt. % polyvinyl alcohol (PVA) on an equal volume basis. The binder, compared to the traditionally-used TEFLON®, shows superior performance. TEFLON® is a very resistive material, but its use in the industry has been widespread due to its good rollable properties. This, however, does not rule out using TEFLON® as a binder. Mixtures of TEFLON® with the aqueous binder and some conductive carbon were used to create rollable binders. Using the aqueous-based binder helps in achieving a significant fraction of the two electron capacity with minimal capacity loss over many cycles. In one embodiment, the binder is water-based, has superior water retention capabilities, adhesion properties, and helps to maintain the conductivity relative to an identical cathode using a TEFLON® binder instead. Examples of hydrogels include methyl cellulose (MC), carboxymethyl cellulose (CMC), hydropropyl cellulose (HPH), hydroxypropylmethyl cellulose (HPMC), hydroxyethylmethyl cellulose (HEMC), carboxymethylhydroxyethyl cellulose and hydroxyethyl cellulose (HEC). Examples of crosslinking polymers include polyvinyl alcohol, polyvinylacetate, polyaniline, polyvinylpyrrolidone, polyvinylidene fluoride and polypyrrole. In one such embodiment, a 0-10 wt % solution of water-cased cellulose hydrogen is cross linked with a 0-10% wt solution of crosslinking polymers by, for example, repeated freeze/thaw cycles, radiation treatment or chemical agents (e.g. epichlorohydrin). The aqueous binder may be mixed with 0-5% TEFLON® to improve manufacturability.

Additional elements can be included in the cathode material including a bismuth compound and/or copper/copper compounds, which together allow improved galvanostatic battery cycling of the cathode. The bismuth compound can be incorporated into the cathode 12 as an inorganic or organic salt of bismuth (oxidation states 5, 4, 3, 2, or 1), as a bismuth oxide, or as bismuth metal (i.e. elemental bismuth). The bismuth compound can be present in the cathode material at a concentration between about 1-20 wt %. Examples of inorganic bismuth compounds include bismuth chloride, bismuth bromide, bismuth fluoride, bismuth iodide, bismuth sulfate, bismuth nitrate, bismuth trichloride, bismuth citrate, bismuth telluride, bismuth selenide, bismuth subsalicylate, bismuth neodecanoate, bismuth carbonate, bismuth subgallate, bismuth strontium calcium copper oxide, bismuth acetate, bismuth trifluoromethanesulfonate, bismuth nitrate oxide, bismuth gallate hydrate, bismuth phosphate, bismuth cobalt zinc oxide, bismuth sulphite agar, bismuth oxychloride, bismuth aluminate hydrate, bismuth tungsten oxide, bismuth lead strontium calcium copper oxide, bismuth antimonide, bismuth antimony telluride, bismuth oxide yittia stabilized, bismuth-lead alloy, ammonium bismuth citrate, 2-napthol bismuth salt, duchloritri(o-tolyl)bismuth, dichlordiphenyl(p-tolyl)bismuth, triphenylbismuth.

The copper compound can be incorporated into the cathode 12 as an organic or inorganic salt of copper (oxidation states 1,2,3 or 4), as a copper oxide, or as copper metal (i.e., elemental copper). The copper compound can be present in a concentration between about 1-70 wt %. In one embodiment, the copper compound is present in a concentration between about 5-50 wt %. In another embodiment, the copper compound is present in a concentration between about 10-50 wt %. In yet another embodiment, the copper compound is present in a concentration between about 5-20 wt %. Examples of copper compounds include copper and copper salts such as copper aluminum oxide, copper (I) oxide, copper (II) oxide and/or copper salts in a +1, +2, +3, or +4 oxidation state including, but not limited to, copper nitrate, copper sulfate, copper chloride, etc. The effect of copper is to alter the oxidation and reduction voltages of bismuth. This results in a cathode with full reversibility during galvanostatic cycling, as compared to a bismuth-modified MnO₂ which will not withstand galvanostatic cycling.

In some embodiments, the cathode material can also comprise an ion selective material, including any of those described herein. The ion selective material can be useful in limiting the migration of zincate ions that reach the cathode into the cathode material. The ion selective material can be incorporated into the cathode mixture prior to formation of the cathode such that the ion selective material is uniformly distributed into the cathode materials. In some embodiments, the ion selective material can be formed as a layer on the exterior of the cathode, or additionally or alternatively, as one or more layers within the cathode itself.

The cathode paste can be formed on a current collector formed from a conductive material that serves as an electrical connection between the cathode material and an external electrical connection or connections. In some embodiments, the cathode current collector can be, for example, nickel, steel (e.g., stainless steel, etc.), nickel-coated steel, nickel plated copper, tin-coated steel, copper plated nickel, silver coated copper, copper, magnesium, aluminum, tin, iron, platinum, silver, gold, titanium, half nickel and half copper, or any combination thereof. The cathode current collector may be formed into a mesh (e.g., an expanded mesh, woven mesh, etc.), perforated metal, foam, foil, perforated foil, wire screen, a wrapped assembly, or any combination thereof. In some embodiments, the current collector can be formed into or form a part of a pocket assembly. A tab can be coupled to the current collector to provide an electrical connection between an external source and the current collector.

The battery can also comprise an anode having an anode material in electrical contact with an anode current collector. In some embodiments, the anode material can comprise zinc, which can be present as elemental zinc and/or zine oxide. In some embodiments, the Zn anode mixture comprises Zn, zinc oxide (ZnO), an electronically conductive material, and a binder. An ion selective material may also be present in the anode mixture in some embodiments. The Zn may be present in the anode material 5 in an amount of from about 50 wt. % to about 90 wt. %, alternatively from about 60 wt. % to about 80 wt. %, or alternatively from about 65 wt. % to about 75 wt. %, based on the total weight of the anode material. In an embodiment, Zn may be present in an amount of about 85 wt. %, based on the total weight of the anode material. Additional elements that can be in the anode in addition to the zinc or in place of the zinc include, but are not limited to, lithium, aluminum, magnesium, iron, cadmium and a combination thereof.

In some embodiments, ZnO may be present in an amount of from about 5 wt. % to about 20 wt. %, alternatively from about 5 wt. % to about 15 wt. %, or alternatively from about 5 wt. % to about 10 wt. %, based on the total weight of anode material. In an embodiment, ZnO may be present in anode material in an amount of about 10 wt. %, based on the total weight of the anode material. As will be appreciated by one of skill in the art, and with the help of this disclosure, the purpose of the ZnO in the anode mixture is to provide a source of Zn during the recharging steps, and the zinc present can be converted between zinc and zinc oxide during charging and discharging phases.

In some aspects, the zinc oxide reagent material described herein can be present in the anode. The zinc oxide reagent material can form a portion of the zinc oxide in the anode and/or can be disposed on a surface of the other zinc based electroactive materials. In some aspects, the zinc oxide reagent material can be used to form an electrochromic window or be visible through a window to allow for in situ observation and measurements of the anode materials during use of the battery. For example, an optical sensor can be used to monitor the capacity, conductance, voltage or the like of the anode and/or battery through observations of the zinc oxide reagent material disclosed herein.

In an embodiment, an electrically conductive material may be present in the anode material in an amount of from about 5 wt. % to about 20 wt. %, alternatively from about 5 wt. % to about 15 wt. %, or alternatively from about 5 wt. % to about 10 wt. %, based on the total weight of the anode material. In an embodiment, the electrically conductive material may be present in anode material in an amount of about 10 wt. %, based on the total weight of the anode material. As will be appreciated by one of skill in the art, and with the help of this disclosure, the electrically conductive material is used in the Zn anode mixture as a conducting agent, e.g., to enhance the overall electric conductivity of the Zn anode mixture. Nonlimiting examples of electrically conductive material suitable for use in in this disclosure include any of the conductive carbons described herein such as carbon, graphite, graphite powder, graphite powder flakes, graphite powder spheroids, carbon black, activated carbon, conductive carbon, amorphous carbon, glassy carbon, and the like, or combinations thereof. The conductive material can also comprise any of the conductive carbon materials described with respect to the cathode material including, but not limited to, acetylene black, single walled carbon nanotubes, multi-walled carbon nanotubes, graphene, graphyne, or any combinations thereof.

The anode material may also comprise a binder. Generally, a binder functions to hold the electroactive material particles (e.g., Zn used in anode, etc.) together and in contact with the current collector. The binder is present in a concentration of 0-10 wt %. The binders may comprise water-soluble cellulose-based hydrogels like methyl cellulose (MC), carboxymethyl cellulose (CMC), hydropropyl cellulose (HPH), hydroxypropylmethyl cellulose (HPMC), hydroxyethylmethyl cellulose (HEMC), carboxymethylhydroxyethyl cellulose and hydroxyethyl cellulose (HEC), which were used as thickeners and strong binders, and have been cross-linked with good mechanical strength and with conductive polymers like polyvinyl alcohol, polyvinylacetate, polyaniline, polyvinylpyrrolidone, polyvinylidene fluoride and polypyrrole. The binder may also be a cellulose film sold as cellophane. The binder may also be TEFLON®, which is a very resistive material, but its use in the industry has been widespread due to its good rollable properties.

In some embodiments, the binder may be present in anode material in an amount of from about 2 wt. % to about 10 wt. %, alternatively from about 2 wt. % to about 7 wt. %, or alternatively from about 4 wt. % to about 6 wt. %, based on the total weight of the anode material. In an embodiment, the binder may be present in anode material in an amount of about 5 wt. %, based on the total weight of the anode material.

A current collector can be used with an anode, including any of those described with respect to the cathode. The anode material can be pressed onto the anode current collector to form the anode. For example, the anode and/or the cathode materials can be adhered to a corresponding current collector by pressing at, for example, a pressure between 1,000 psi and 20,000 psi (between 6.9×10⁶ and 1.4×10⁸ Pascals). The cathode and anode materials may be adhered to the current collector as a paste. A tab of each current collector, when present, can extend outside of the device to form the current collector tab.

An alkaline electrolyte (e.g. an alkaline hydroxide, such as NaOH, KOH, LiOH, or mixtures thereof) can be contained within the free spaces of the electrodes. In some embodiments, the electrolyte can comprise an acidic solution, alkaline solution, ionic liquid, organic-based, solid-phase, gelled, etc. or combinations thereof that conducts lithium, magnesium, aluminum and zinc ions. Examples include chlorides, sulfates, sodium hydroxide, potassium hydroxide, lithium hydroxide, perchlorates like lithium perchlorate, magnesium perchlorate, aluminum perchlorate, lithium hexafluorophosphate, [M⁺[AlCl⁴⁻](M⁺)]-sulphonyl chloride or phosphoryl chloride cations, 1-ethyl-3-methylimidazolium bis (trifluoromethyl sulfonyl)imide, 1-ethyl-3-methylimidazolium trifluoromethanesulfonate, 1-butyl-1-methylpyrrolidinium bis(trifluoromethylsulfonyl)imide,1-hexyl-3-methylimidazolium hexofluorophosphate,1-ethyl-3-methylimidazolium dicyanamide,11-methyl-3-octylimidazolium tetrafluoroborate, yttria-stabilized zirconia, beta-alumina solid, polyacrylamides, NASICON, lithium salts in mixed organic solvents like 1,2-dimethoxyethane, propylene carbonate, magnesium bis(hexamethyldisilazide) in tetrahydrofuran and a combination thereof. The electrolyte may have a concentration of between 5 wt % and 60 wt %. The battery base electrolyte may comprise an acidic electrolyte, zinc sulfate or zinc chloride. The electrolyte can be in a liquid or gelled form. When the electrolyte is in the form of a gel, the gelled electrolyte can be formed by mixing a cellulose derivative and an alkaline solution.

In some embodiments, one or more additives can be used in the electrolyte, the anode, or the cathode to control gassing during cycling of the battery. For example, bismuth, indium, indium acetate, phosphate esters, or any combination thereof can be added to the electrodes and/or electrolyte.

A separator can be disposed between the anode and the cathode when the electrodes are constructed into the battery. The separator 3 may comprise one or more layers. Suitable layers can include, but are not limited to, a polymeric separator layer such as a sintered polymer film membrane, polyolefin membrane, a polyolefin nonwoven membrane, a cellulose membrane, a cellophane, a battery-grade cellophane, a hydrophilically modified polyolefin membrane, and the like, or combinations thereof. As used herein, the phrase “hydrophilically modified” refers to a material whose contact angle with water is less than 45°. In another embodiment, the contact angle with water is less than 30°. In yet another embodiment, the contact angle with water is less than 20°. The polyolefin may be modified by, for example, the addition of TRITON X-100™ or oxygen plasma treatment. In some embodiments, the separator 3 can comprise a CELGARD® brand microporous separator. In an embodiment, the separator 3 can comprise a FS 2192 SG membrane, which is a polyolefin nonwoven membrane commercially available from Freudenberg, Germany.

The separator can comprise at least one layer of ion selective material as described herein. For example, the separator can comprise an ion selective material formed as a layer within of the separator layers or as a freestanding layer. In some alternative embodiments, the electrodes (e.g., the anode and/or the cathode) can comprise the ion selective material layers and the separator 3 may be free of an ion selective material or layer.

The various materials can be assembled into a battery and discharged to allow use of the battery 10 as a primary cell, or cycled (e.g., discharged and charged) to allow use of the battery 10 as a secondary cell. The zinc oxide reagent material can be present to allow use of the cell to provide a large discharge while the remaining zinc electroactive materials can be used to provide a lower discharge rate over time. In some aspects, the zinc oxide reagent material can be used to monitor the state of the electrodes and/or battery using any of the techniques described herein.

As described herein, an electrochromic phenomenon can be created in ZnO formed in alkaline electrolytes. Visible light absorption and conductivity change by factors of 1,000 during an electrochemical reaction process in which H⁺ or O²⁻ transfer from an electrolyte and ˜1 mAh per g-ZnO of electrons transfer from an electrode to compensate for charge neutrality. Simultaneously the bandgap width changes by 0.28 eV. These changes to electronic properties may be used in the design of Zn-alkaline batteries, resistive switching, transparent conductive coatings, resistive memory, and energy-efficiency windowing.

### EXAMPLES

The subject matter having been generally described, the following examples are given as particular aspects of the disclosure and are included to demonstrate the practice and advantages thereof, as well as preferred aspects and features of the inventions. It should be appreciated by those of skill in the art that the techniques disclosed in the examples which follow represent techniques discovered by the inventors to function well in the practice of the inventions, and thus can be considered to constitute preferred modes for its practice. However, those of skill in the art should, in light of the present disclosure, appreciate that many changes can be made in the specific aspects which are disclosed and still obtain a like or similar result without departing from the scope of the inventions of the instant disclosure. It is understood that the examples are given by way of illustration and are not intended to limit the specification of the claims to follow in any manner.

### Experimental Methods

Generation of Electrochromic ZnO—Unless otherwise specified, electrochromic ZnO was generated by holding the electrochemical potential of Zn metal foil 0.2 V above Zn equilibrium in 5.5 M KOH electrolyte, previously saturated with ZnO, until a layer of electrochromic ZnO was visible on the surface of the Zn foil. Zn foil was used as a counter electrode and a separate Zn wire was used as a reference electrode.

ZnO gravimetric capacity measurement—Electrochromic ZnO was generated on a 0.25 mm thick Zn metal foil electrode. ZnO mass was calculated from the discharge capacity of the Zn foil and corroborated by measuring the ZnO layer thickness in situ with an optical microscope. Chronoamperometry was performed at selected potentials between 0.03 V and 1.00 V to obtain capacities for each potential range.

UV-vis spectroscopy—Electrochromic ZnO was generated in situ on a 5 mm by 5 mm Zn foil electrode positioned at a 45° angle coincident to the illumination windows in a UV-vis cuvette. An Ocean Optics DH-miniUV-Vis-NIR Light source with deuterium and halogen lamp was used as a light source, and a Gamry Spectro-115U UV-vis spectrometer was used to collect in operando UV-vis spectra in a reflection geometry.

Electrochemical Impedance Spectroscopy—Electrochromic ZnO was generated on a 0.25 mm thick Zn metal foil electrode contacted with two copper wires spaced 0.67 mm apart. Zn converted to electrochromic ZnO and the copper wires were observed to be in contact only with the electrochromic ZnO. Chronoamperometry was performed on the Zn/ZnO electrode to control the electrochemical potential of the ZnO. Simultaneously, EIS was performed on the ZnO via the copper wires with a second potentiostat. EIS measurements were taken between 150 kHz and 1 Hz.

X-Ray Diffraction—Electrochromic ZnO was generated on a 0.05 mm thick Zn metal foil electrode. XRD measurements were then taken on the electrochromic ZnO at selected potentials between 0.05 V and 1.5 V. Zn electrode potential was then held at 0.5 V for 14 hours until layer of amber ZnO was visible with an optical microscope. XRD measurements were then taken on the amber ZnO. XRD Measurements were taken using 15 keV X-rays from the 5-ID SRX beamline at National Synchrotron Light Source II at Brookhaven National Laboratory.

Confocal Raman Spectroscopy—Raman spectroscopy measurements were taken on ZnO generated in 5.5 M potassium hydroxide electrolyte prepared with water, 5.5 M potassium hydroxide electrolyte prepared with deuterium oxide, and 5.5 M sodium hydroxide electrolyte prepared with water. Each electrolyte was previously saturated with ZnO. Electrochromic ZnO was generated on a 0.25 mm thick Zn metal foil electrode by holding electrode potential 0.2 V above Zn equilibrium. Amber ZnO was generated on a 0.25 mm thick Zn metal foil electrode by holding electrode potential 0.5 V above Zn equilibrium for 12 hours until a layer of amber ZnO accumulated. Confocal Raman measurements were taken on the electrochromic ZnO at selected potentials between 0.01 V and 1.5 V. A WITec alpha300R Confocal Raman Microscope with A 50×: ZeissEC Epiplan, NA 0.75 HD objective was used to obtain measurements of the ZnO accumulated on a Zn foil electrode. For the presented data, either a 532 nm laser at ˜1 mW or a 633 nm laser at ˜5 mW was used. 300 acquisitions of 1 second each were taken and signal averaged. A Princeton Advanced Research Versastat 4 was used to control potential.

Energy Dispersive X-ray Spectroscopy (EDS)—EDS was performed with an EDAX EDS installed on the Zeiss Supra 55VP Field Emission Scanning Electron Microscope. EDS was performed on blue-colored ZnO collected via the following method. Zn foil was discharged in 5.5 M KOH until electrochromic ZnO was accumulated. The foil samples were soaked in deionized water for 24 hours to remove residual KOH. They were then dried in ambient conditions for 24 hours prior to imaging. EDS was performed on the surface of the visibly blue ZnO electrode. Sensitivity was ˜0.5% mole fraction.

X-ray Photoelectron Spectroscopy (XPS)—XPS was performed with a Physical Electronics Versaprobe II XPS. ZnO was prepared and studied as described above.

### Example 1

To quantify the color change (FIG. 8a), in operando ultraviolet-visible (UV-vis) spectroscopy was performed as a function of electric potential. Measurements were performed in reflection mode (FIG. 8b) wherein a ˜0.05 mm thick layer of electrochromic ZnO was formed on the face of a 5×5 mm foil zinc electrode in a UV-vis cuvette. Specular reflected light intensity at a 45° incidence was measured at voltages ranging from 0.01 to 1.5 V and wavelengths from 300 to 800 nm. Because the ZnO layer was a bonded powder, a Kubelka-Munk (K M) diffusereflectance analysis was performed to quantify the ZnO optical absorption coefficient, a, and the band gap.

The optical absorption coefficient a rises by a factor of 1,000 as electric potential is decreased from 0.60 to 0.02 V (FIG. 8c). The material is ˜25×more absorptive to red wavelengths than to blue wavelengths when the potential is ˜0.0 V, resulting in blue coloration. Combining the colorimetry data with the charge transferred, Q, and electrode area, A, allows a calculation of a coloration efficiency (CE) via Eqn. 4, of ˜50 cm²/C, which is similar to other high-efficiency electrochromic materials, suggesting ZnO could be used in low-energy electrochromic devices.

The UV-vis data and K-M analysis also allow calculation of the band gap using a Tauc plot (FIG. 8d), where the band gap is a function of a and the energy quanta of light absorbed, hv. When the ZnO is held at 0.6 V or higher, we measure its band gap to be 3.38 eV (FIG. 8d), close to the literature consensus of 3.37 eV.⁵ Decreasing the potential to 0.02 V results in a band gap increase to 3.65 eV. This increase is likely a result of the Burstein-Moss effect, in which the rising Fermi level causes an increase in the transition energy required to promote an electron from below the bandgap to empty states.

### Example 2

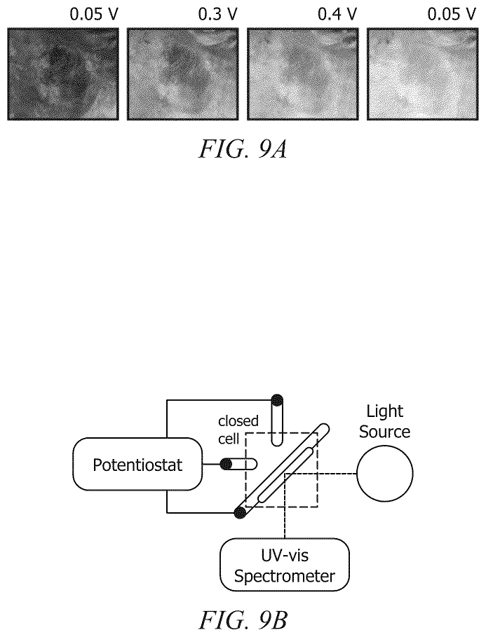

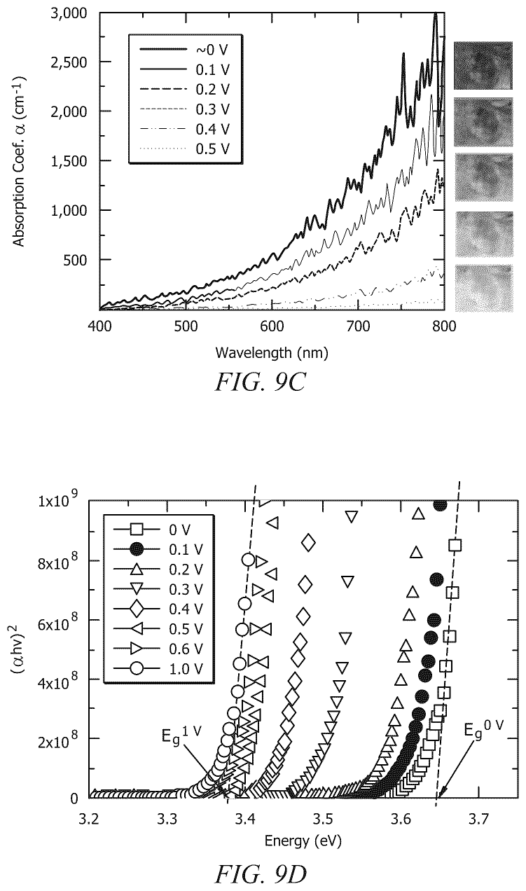

In operando electrochemical impedance spectroscopy (EIS) was performed to quantify conductivity changes (FIG. 9a). EIS was performed on the electrochromic ZnO material (a bonded particle network) at potentials between 0.02 V and 0.6 V. The electrical resistance of the electrochromic ZnO material decreases by more than 1,000× as the material colors blue (FIG. 9b). A basic schematics shown in FIG. 9a inset. Although an alternative hypothesis for this decrease in resistance is creation of interpenetrating particles of Zn metal, the UV-vis, Raman, and XRD measurements provide evidence that electrons physically insert into the ZnO structure and that no Zn metal is formed.

### Example 3

In operando X-ray diffraction—This example investigates the underlying crystallographic defects and molecular-scale mechanisms causing the electrochromic behavior. In operando synchrotron XRD measurements were performed on a 0.05 mm thick layer of electrochromic ZnO (FIG. 10a) to characterize crystallographic phases and structural changes. These same measurements were also performed on an amber-colored layer that consistently forms between the electrochromic ZnO and the Zn metal if the potential is held higher than 0.2 V for several hours (FIG. 10a). All XRD data reveal only wurtzite ZnO peaks of the same height for all materials, regardless of electrode potential (FIG. 10b).

This result establishes that no other crystallographic phases, neither Zn metal nor zinc hydroxide, are present in either the amber or electrochromic ZnO in concentrations above the XRD signal-to-noise ratio of ˜0.5%. The data also show the d-spacing of both layers decreases as electrode potential changes from 0.02 V to 0.6 V (FIG. 10c), corresponding to a contraction of the ZnO lattice size (inset, FIG. 10c). Contraction of the ZnO lattice halts after the voltage rises above 0.6 V, coinciding with the end of insertion of charge. This contraction is explainable by noting that as voltage is increased to 0.6 V, the density of conduction-band electrons decreases. A reduction in conduction-band electrons should reduce the electric-field screening between Zn²⁺ and O²⁻ ions in the lattice, thus resulting in contraction of the crystal lattice. Electrochromic materials typically undergo a change of crystal structure during color change, but our result is similar to the behavior of electrochromic VO₂, which shows only a slight lattice expansion and low levels of electron insertion. Similar lattice expansion is also observed in thermally hydrogenated Al-doped ZnO thin films which do not show electrochromism.

### Example 4

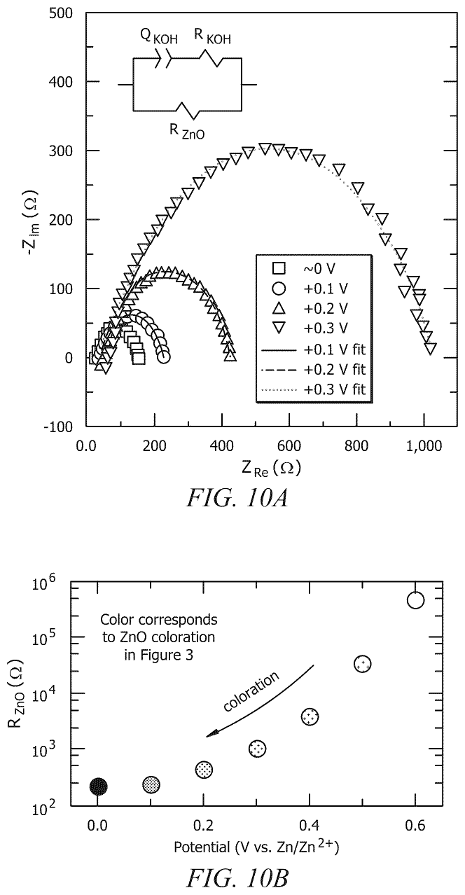

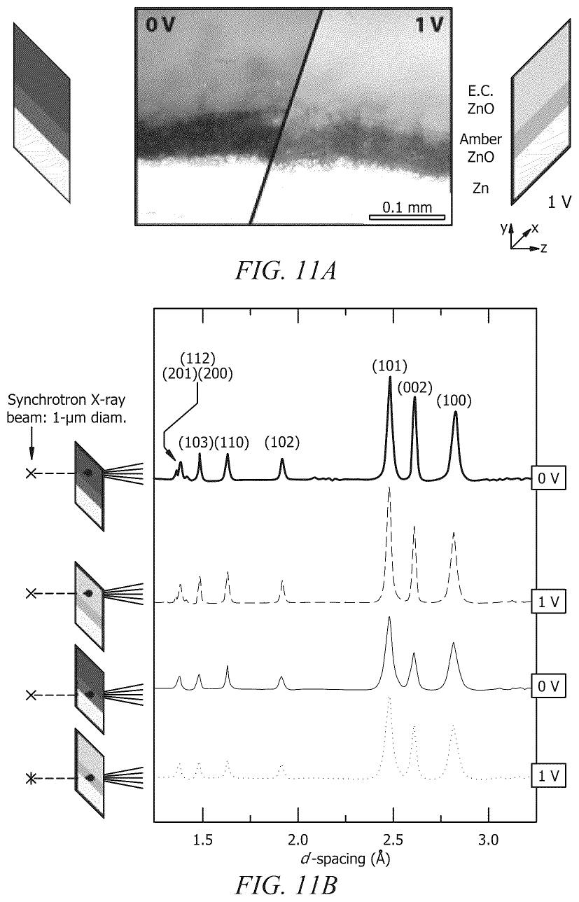

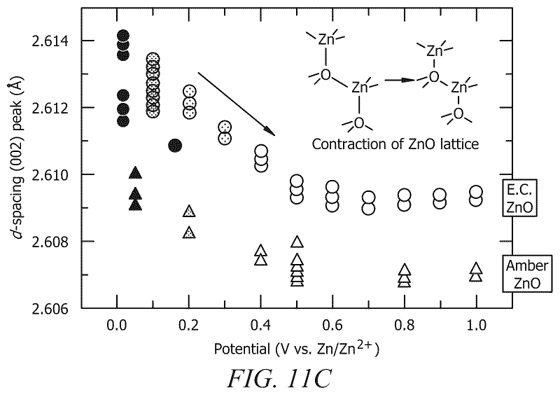

In operando confocal Raman spectroscopy—Confocal Raman spectroscopy performed on the electrochromic and amber ZnO in operando (FIG. 11a) gives further insights into defect identities that enable the control of ZnO electronic properties. In electrochromic ZnO, characteristic wurtzite ZnO E₂ phonons are present regardless of electrode potential (FIG. 11b), corroborating the XRD results that show only ZnO phases. Peaks at characteristic ZnO longitudinal optical (LO) and transverse optical (TO) frequencies (FIG. 11c) are also observed, whose shifts and intensities vary as a function of potential. The dynamic behavior of the LO mode provides information on the source of conductivity, type of defects, and band structure of electrochromic ZnO.

LO modes couple to the electron plasma in polar solids via LO-phonon-plasmon (LPP) coupling, which allows for indirect observation of conduction electrons through measurement of the LO mode. LPP coupling forms two LO modes, where one has plasmonic character (LPP+), and one has phononic character (LPP−). At high conduction electron concentration, LPP+ broadens and takes the frequency of the plasma, making it difficult to observe. Conversely, LPP− becomes narrow and takes the frequency of the TO phonon because the electronic plasma screens the longitudinal coulombic forces. LPP− appears in our Raman spectra as the voltage is decreased below 0.6 V (FIG. 11c), suggesting that inserted electrons are supplied to the ZnO conduction band. This observation, consistent with UV-vis and XRD results, indicates added conduction electrons are responsible for the increased n-type conductivity observed with EIS.

The behavior of the LO phonon also indicates the presence of oxygen vacancies, V_{O}, and suggests a variability of the V_{O} charge state in electrochromic ZnO. Observation of the LO mode has been used to reveal V_{O} in ZnO in many other works. Here, it is observed that when the ZnO is held at 1.0 V, the LO peak is stronger under 532 nm Raman stimulation compared to 633 nm stimulation. Conversely, when the ZnO is held near 0.0 V, the LO peak is stronger under 633 nm stimulation (FIG. 5d). This LO mode behavior is attributed to resonance Raman scattering, wherein the peak is stronger when the excitation energy is near the energy of electronic transitions such as a band gap or defect transition.

Here, the Raman stimulation photon energies are close to the transition energies of V_{O} in ZnO as proposed in previous literature. Specifically, the transition of V_{O} between the 2+ charge state and the 0 charge state, V_{O}(2+/0), is proposed to be 2.42 eV above the valence band maximum (VBM) which is close to the energy of 532 nm light, and the V_{O}(+/0) transition is proposed to be 1.94 eV above the VBM, which is close to the energy of 633 nm light. Therefore, a hypothesis explaining the observed height of the LO phonon peak is that V_{O}²⁺ states are full (and V_{O}⁺ states are empty) when the ZnO electrochemical potential is 1.0 V. When the ZnO electrochemical potential approaches 0.01 V, the V_{O}⁺ states are filled, and the V_{O}²⁺ states are emptied. A parallel behavior is seen in WO₃⁴⁰ wherein V_{O}⁺ is believed to contribute to blue coloration, suggesting a similar mechanism could occur in ZnO. Notably, a redshift in the resonantly enhanced LO mode is also observe as potential goes from 0.01 V to 1.0 V (FIG. 11c), which has been observed accompanying increased charge carrier concentration and increased disorder due to doping.

The LO mode behavior are on the amber ZnO, which also displays a strong LO mode at 1.0 V but does not show characteristic wurtzite E₂ modes (FIG. 11b), suggesting strong crystallographic disorder, perhaps dominated by V_{O} defects. Amber (orange/red) coloration of ZnO is seen in other publications that use different pre-treatments or environments, and V_{O} is identified there as the source of amber coloration.

In operando Raman measurements on the electrochromic ZnO also provide evidence of proton (E1+) defects in addition to V_{O} defects. Raman spectra acquired on ZnO generated in 5.5 M KOH in D₂O electrolyte with 18 deuterons (D⁺) to every 1H⁺ display a unique mode at 390 cm⁻¹ at both 1.0 V and 0.01 V (FIG. 11e) that is not present in ZnO generated in standard 5.5 M KOH. By replacing H⁺ with D⁺, a mode obscured by the ZnO E^{high} peak in standard KOH electrolyte is shifted to a lower frequency, where it becomes distinguishable. Since D⁺ should insert into the ZnO crystal lattice similarly to H⁺, this demonstrates that H⁺ (or D⁺) are present in the ZnO regardless of electrode potential. Hydrogen impurities are stable in ZnO at room temperature, supporting this claim.

### Example 5

To investigate potential alkali-doping, we performed EDS and XPS on blue-colored electrochromic ZnO, generated in KOH, that had been soaked in deionized water to remove residual KOH, and neither analysis showed presence of potassium above the detection limits of ˜0.5% mole ratio. Additionally, ZnO generated in 1.4 M tetrabutylphosphonium (TBP) hydroxide also exhibits electrochromic coloration, further suggesting alkali impurities are not necessary for coloration. However, it is possible potassium exist at concentrations below the detection limit in EDS and XPS, and that alkali impurities were present in the as-purchased TBPOH electrolyte. We also observe electrochromic ZnO exhibits identical color-change after transfer to a series of solutions of TBPOH, which do not contain K⁺ or Na⁺ except for what comes with the electrode from the previous bath. The TBP cation is too bulky for insertion. Electrochromic ZnO cycling was tested in three consecutive vials of stirred TBPOH electrolyte. This series of dilutions greatly decreases the amount of Zn²⁺, Na⁺, and K⁺ in the free electrolyte, establishing H⁺ or V_{O} as the inserting ionic species.

Additionally, Raman spectra acquired on ZnO generated in KOH and NaOH are identical (FIG. 11e), consistent with H⁺ insertion or V_{O} generation. This suggests two possible half electrode reactions. It is still possible that trapped K⁺ or Na⁺ exists in the electrochromic ZnO material at small concentrations undetected by the EDS and XPS analyses. Such impurities are unlikely to be exchanged with the electrolyte during the electrochromism because no effect is seen from the TBPOH dilution series, but they could statically enable defect sites that host the exchange reactions 5 and 6.

These proposed reaction mechanisms agree with relevant literature. In other electrochromic materials, including VO₂ and WO₃, simultaneous insertion of protons and generation of V_{O} are thought to occur, and in ZnO-based resistive switching devices, V_{O} has been posited as the dynamic species.

Our observations of increased conductivity accompanying electron insertion and of the presence of the LPP− phonon near 0.0 V are indicative of n-type conditions. In pure ZnO, V_{O} in is probably a deep donor that cannot participate in n-type conductivity, whereas hydrogen impurities act as shallow donors, which would increase conductivity. FIG. 11f summarizes the energies of H⁺ and V_{O} defects in their various charge states in a simplified band diagram, using literature values for pure ZnO. Thus, if electrochromic ZnO is free of K⁺ and Na⁺, then H⁺ defects are most likely the exchanged ion. On the other hand, if K⁺ or Na⁺ in the material at 1 part in ˜300 and play static roles in stabilizing the electro-active defects, then the system is novel, and it is unclear whether H⁺ or V_{O} are the dynamic species.

Simultaneous insertion of protons and electrons in ZnO was previously observed via proton-coupled electron transfer (PCET) reactions and charge-compensating proton uptake reactions. In alkaline electrolytes, protons are abundantly available through the aqueous hydrolysis reaction that proceeds when electrode voltage is more negative than the hydrogen evolution reaction. Indeed, small amounts of hydrogen gas bubbles from hydrolysis is seen in each of our time-lapse supplemental videos, confirming a supply of H⁺.

### Example 5

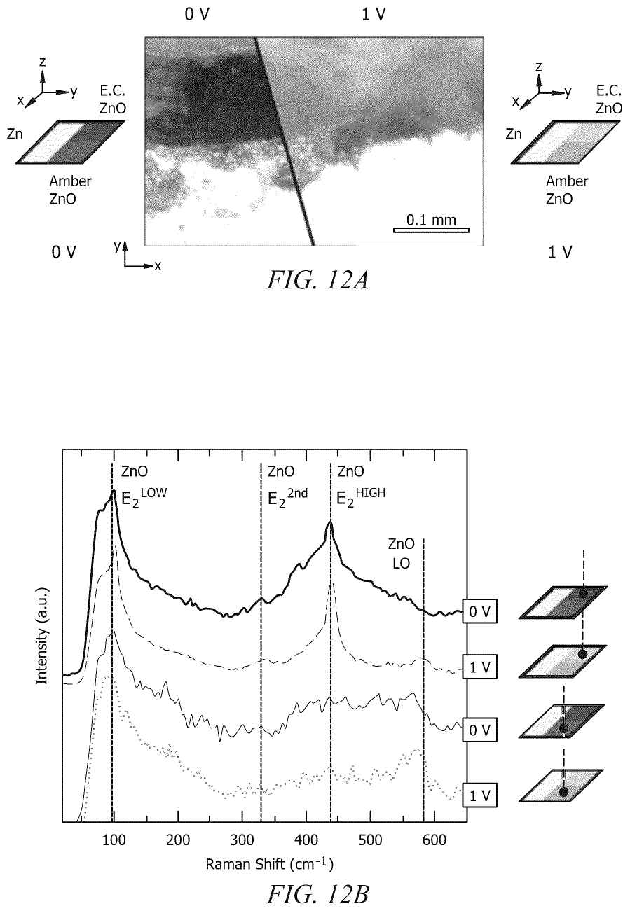

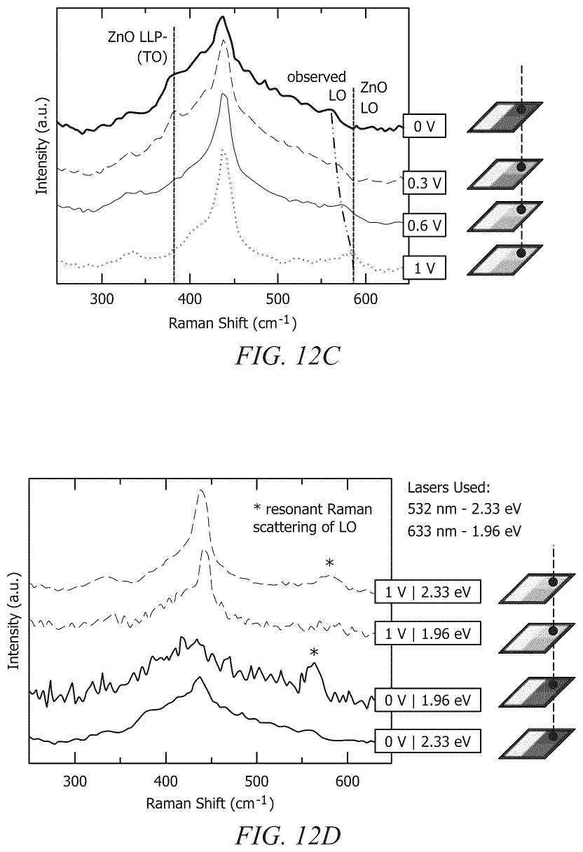

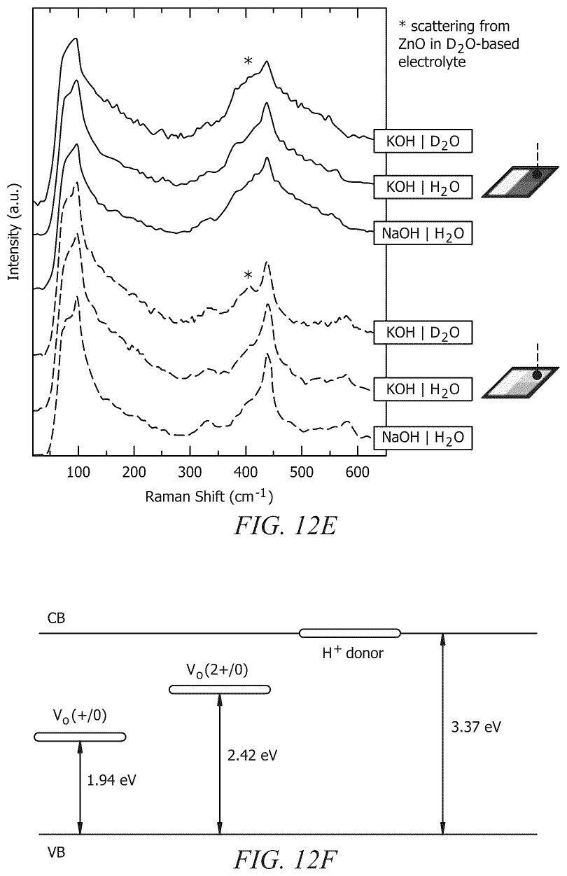

A Zn-alkaline cell was constructed with a viewing window allowing for in operando optical observation (FIG. 12a). Battery-grade Zn powder bound by 5% w/w polytetrafluoroethylene (PTFE) binder comprised the Zn paste electrode. Electrolytic manganese dioxide (MnO₂) was used for the cathode and was oversized to ensure the cell would fail from Zn effects.

The cell was discharged at 25 mA/g-Zn for 19 hours (FIG. 12b, 60% theoretical Zn capacity) before the Zn particles passivated and Zn electrode potential increased to −1.25 V vs. a zinc reference in the same electrolyte, which triggered end of discharge and open circuit voltage (OCV). The ZnO material behavior was observed in operando during discharge (FIG. 12a). ZnO color in this environment is reliably correlated with conductivity. Thus, ZnO color was analyzed by capturing red, green, and blue (RGB) color values with a microscope camera in each of the time-lapse images (FIG. 12c). Relative RGB values, i.e. the change from initial values, show (FIGS. 12a(i) and 12a(ii)) the development of blue ZnO continually grows stronger until electrochromic ZnO physically encapsulates all visible Zn particles (12a(iii)) in core-shell geometries.

Just prior to electrode failure, the potential is ˜0.2 V, and blue coloration dominates (FIG. 12a(iii)). As the discharge pushes the potential above 0.2 V, the color suddenly changes to white (FIGS. 12c and 12a(iv)) simultaneously as electrode passivation occurs (FIG. 12b) and the electrode fails further discharge. This electrode failure is almost certainly due to sudden conductivity switch of the ZnO material that coats the metallic Zn cores. FIG. 12c plots the expected conductivity of this ZnO coating based on EIS measurements. This provides novel insights and applications for zinc alkaline electrodes, including (1) the very common electrode failure must be, in at least some cases, due to sudden conductivity changes in ZnO material coating the metallic Zn grains, and (2) control tactics are made possible by this knowledge in which a reference electrode or color sensor provide feedback from the battery to a battery management system (BMS), wherein the BMS controls the voltage to avoid the conductivity failure mechanism. These results will be of urgent interest to researchers in the Zn battery industry and related research fields.

### Example 6

An electrochromic window was constructed by slurry-sedimentation casting electrochromic ZnO particles on an indium tin oxide (ITO) transparent conductive electrode and then cycling between −0.1 V and 1.1 V vs. a Zn wire counter electrode. Repeatable changes in transparency were observed. For visual contrast, a white piece of paper with a black “+” shape was placed on the backside of the window. During the potentiostatic step at −0.1 V, blue coloration is accompanied by a decrease in each of relative RGB values, consistent with a darkening of the window. Additionally, during coloration, relative red color values decrease more than blue or green values, consistent with blue coloration. This device demonstrates the feasibility of construction of fully functional ZnO-based electrochromic windows in future work. Future substitution of aluminum-doped zinc oxide for the ITO would allow an “all zinc” electrochromic window device.

### Example 7

Test cells were created to test the materials described herein. Zn metal foil, potassium hydroxide (KOH), sodium hydroxide (NaOH), and lithium hydroxide (LiOH) were purchased from Fisher Scientific. Tetrabutylphosphonium hydroxide was purchased from Sigma Aldrich. Nickel foil was purchased from Ametek. J-B Weld Clearweld (Clear Epoxy), Devcon 5-minute Epoxy Gel (Structural Epoxy), poly(methyl methacrylate) (acrylic), Thermo Scientific plain microscope slides, Thermoscientific Microscope Cover Glass No. 1 Thickness were purchased from McMaster Carr.

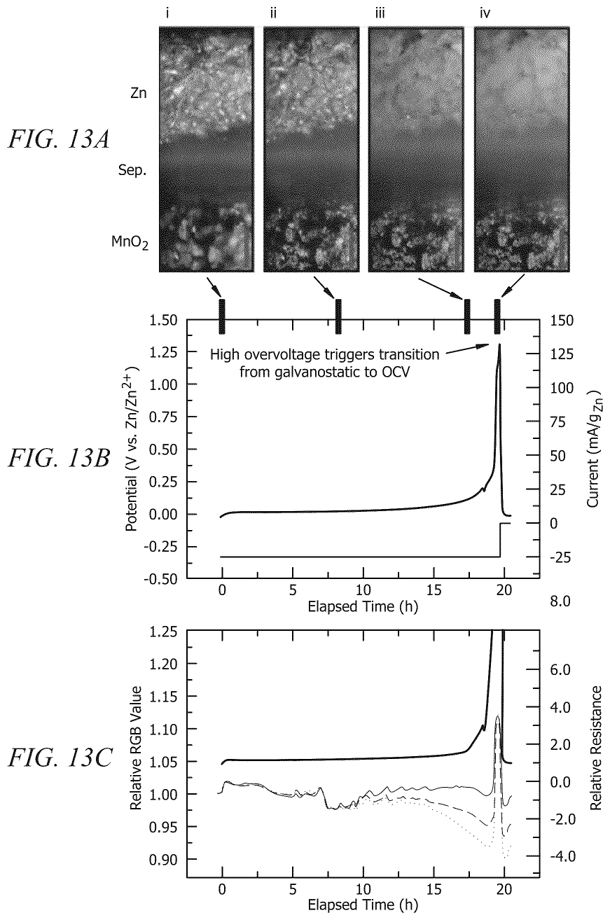

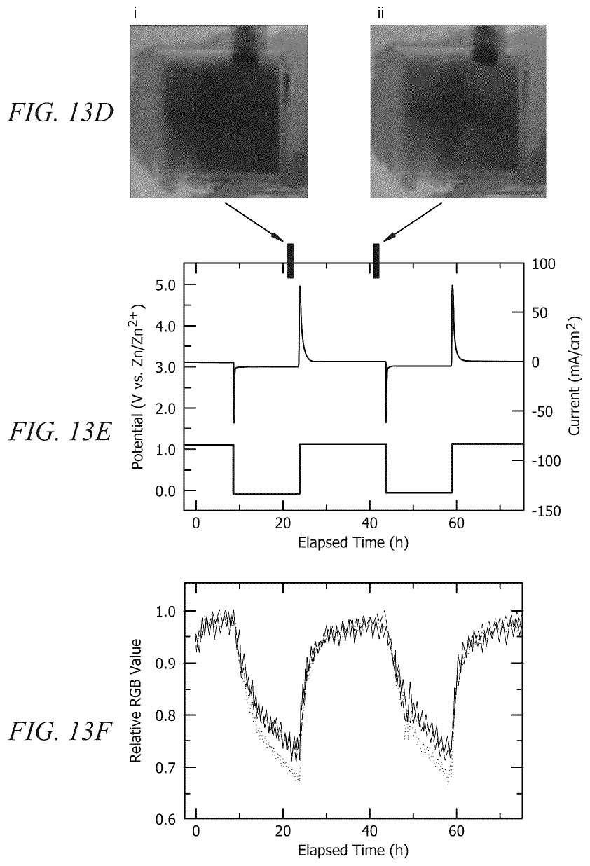

Zn foil electrodes for operando optical microscopy and Raman spectroscopy measurements were constructed by sandwiching one end of a 1 cm wide, 0.25 mm thick strip of Zn foil between 0.3 mm thick glass using clear epoxy to seal. The other end of the foil was left unsealed for connection to a potentiostat. The edge of the foil sandwiched between epoxy was left exposed to the electrolyte as shown in FIG. 13A-13D.

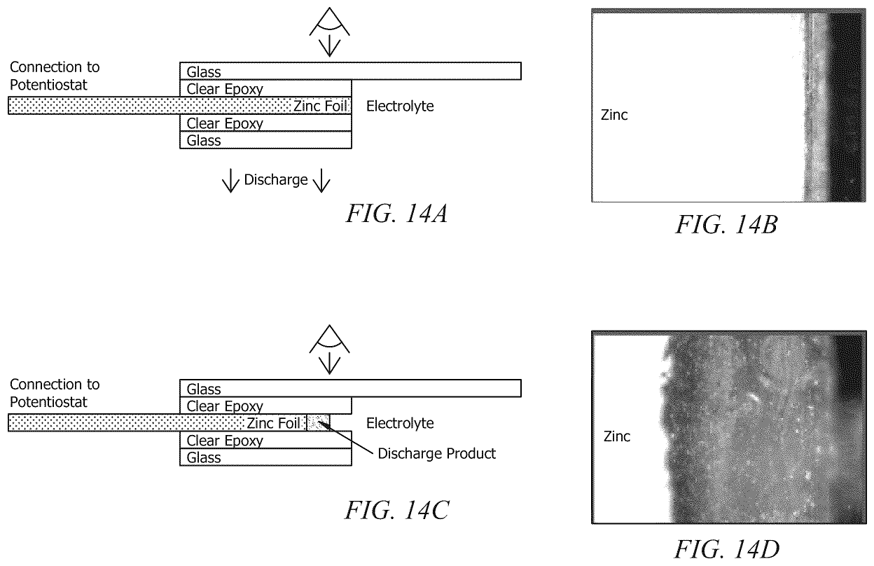

Zn foil electrodes were incorporated into electrochemical cells using either MnO₂, NiOOH, or nickel foil as a cathode for generation of ZnO. A Zn wire was used as a reference electrode as shown in FIG. 14.

A ToupCam model E3ISPM20000KPA digital camera mounted on an Olympus Microscope model BX51RF with a 10× or 20× Olympus LMPIanFLN objective was used to obtain in operando images. Homemade software was used to automate image capture and generate time lapse videos with electrochemical data.

Zinc (Zn) foil was discharged at a constant current of 20 mA/cm² of exposed foil area in 5.5 M KOH. Foil receded, and then electrochromic ZnO accumulated adjacent to the surface of the Zn foil. Once electrochromic ZnO began to accumulate, gas bubbles were observed forming on the surface of the ZnO. On charge, the electrochromic ZnO converted back to Zn metal.

Electrochromic ZnO was observed after Zn foil was discharged at 0.2 V in 5.5 M KOH pre-saturated with zincate. The electrode potential was held in increments of 0.1 V between ˜0 V and 0.5 V with an open circuit voltage (OCV) step between each positive potential to show reversibility. Reversible color change of electrochromic ZnO was clearly demonstrated. Heterogeneity results from spatial variability is due to localized mass transfer limitations and ionic conductivity limitations.

A 5 mm by 5 mm Zn foil planar electrode was discharged at 0.2 V until a continuous layer of electrochromic ZnO accumulated, coving the foil.

Next the foil was subjected to potentiostatic discharge at 0.2 V. Zn foil was discharged at a constant electrode potential of 0.2 V in 5.5 M KOH pre-saturated with zincate. Electrochromic ZnO formed first. After a layer of electrochromic ZnO covered the surface of the Zn metal, amber ZnO built up between the electrochromic ZnO and the Zn metal surface.

The foil was Cycled in tetrabutylphosphonium hydroxide (TBPOH) electrolyte. ZnO on Zn foil was cycled in consecutive vials of TBPOH electrolyte to demonstrate K+ is not required for coloration. The results show that the coloration change occurred even in TBPOH.

### Example 8

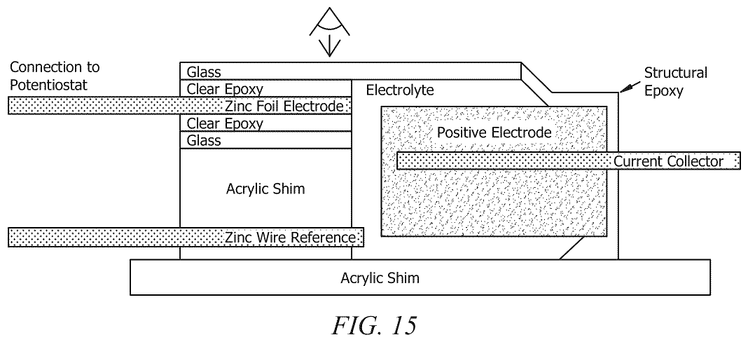

The capacity of the ZnO was measured. Electrochromic ZnO was accumulated on a 0.25 mm thick Zn foil electrode in KOH electrolyte saturated with ZnO by holding the potential at 0.2 V for approximately 1 hour (FIG. 15). The discharge capacity was 4.5 mAh, indicating ˜5.5 mg of Zn metal was discharged (Zn gravimetric coulombic capacity: 820 mAh/g). If 100% of the discharged Zn metal precipitated to form ZnO, then ˜6.8 mg ZnO would be accumulated (Zn and ZnO molar masses: 65.4 and 81.4 g/mol, respectively).

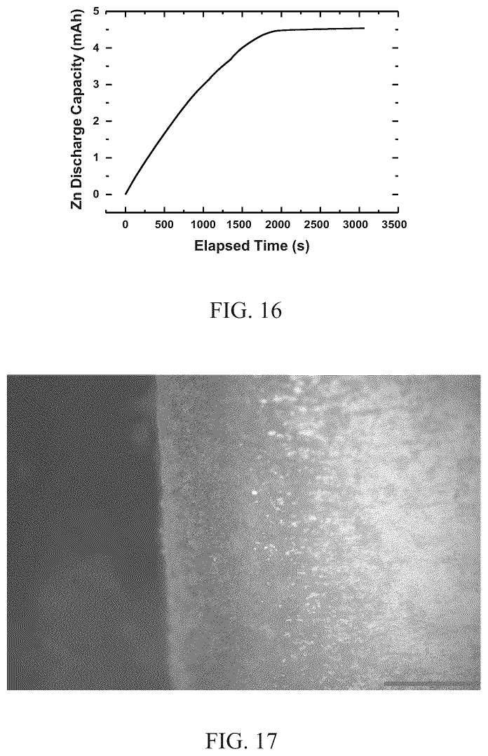

To corroborate this, the thickness of the ZnO layer was ˜0.5 mm thick (FIG. 16). Based on the electrode dimensions (1 cm long×0.25 mm deep), ZnO volume was 1.25 mm³, so ˜7 mg ZnO accumulated on the electrode (ZnO density: 5.6 g/mol).

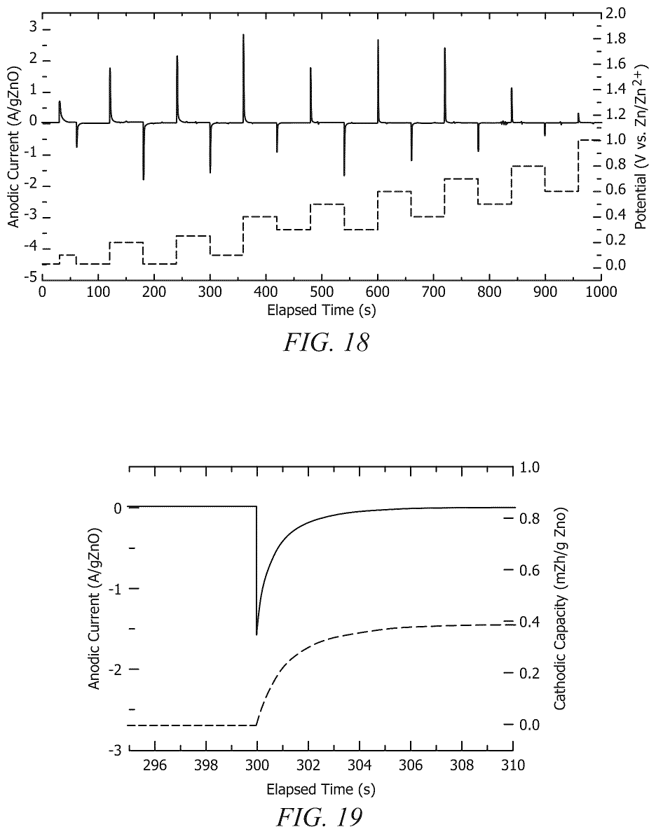

To calculate specific capacity of ZnO, chronoamperometry was performed in intervals between 0 V and 1 V. In the first ˜5 seconds after a voltage change, a current spike was observed resulting from insertion or disinsertion of electrons into the ZnO. Current was adjusted to measure only electron insertion into the ZnO by subtracting the baseline current after the current spike as shown in FIG. 17 for current response and voltage steps. The current spikes observed after each voltage step were integrated to calculate the charge inserted in that potential window. FIG. 18 is an example cathodic current and capacity accompanying ZnO coloration.

This calculation was performed for voltage steps between 0.03 V and 1 V. Approximately 1 mAh/g ZnO accompanies a potential change from 1 V to 0.03 V. 0.03 V, which was chosen as a lower limit in order to prevent loss of ZnO mass resulting from Zn plating. Note that passivation of Zn metal occurs at 0.28 V, so accurate calculations could not be obtained near that potential. We assumed capacity from 0.25 V to 0.3 V was the same as measured between 0.2 V and 0.25 V.

### Example 9

Electrochromic ZnO Cyclability—Electrochromic ZnO was generated via oxidation of Zn foil at 0.2 V. The ZnO on Zn foil was then cycled 35,000 times over the course of 4 days. One cycle consists of 5 seconds of chronoamperometry at 0.05 V followed by 5 seconds of chronoamperometry at 1.0 V. Visible light photographs of the ZnO layer were taken at 0.05 V and 1.0 V at selected cycles to observe changes in coloration. Notably, reversible charge insertion and coloration was still observed after 35,000 cycles indicating a high reversibility of defect generation.

### Example 10

Ultraviolet-Visible Spectroscopy—A Gamry Spectro-115U UV-vis spectrometer was used to collect UV-vis spectra. A Princeton Advanced Research Versastat 4 was used to control electrode potential. An Ocean Optics DH-mini UV-Vis-NIR Light source with deuterium and halogen lamp was used as a light source. Reflection geometry was used because the ZnO powder needs an ohmic connection to the opaque Zn electrode.

Illumination of the ZnO powder on the Zn foil causes reflected spectral radiance (W sr⁻¹ m⁻² nm) from the ZnO material. The Zn metal behind the ZnO powder is not visible, and we observe no fluorescence in this spectral range of input, therefore the reflected spectral radiance is completely due to reflection from the ZnO powder's many surfaces and attenuation during passage through the ZnO material.

To obtain the absorption coefficient, a Kubelka-Munk analysis was undertaken, which is outlined below.
I is the intensity of light incident on the powder material, travelling away from the light source.
J is the intensity of light coming out of the powder material, travelling toward the detector.
H is the summed intensity of light going in all directions perpendicular to I or J
We model H, I, J, as pointed normal to the six sides of a cube. So, H has four directions, I has one, and J has one. H, I, and J are always positive, by definition.

$$\frac{dI}{dx} = - α {ε}_{nO} I - \frac{5}{6} SI + \frac{1}{6} SJ + \frac{1}{6} SH \qquad ( 100 )$$

$$\frac{dJ}{dx} = α {ε}_{ZnO} J + \frac{5}{6} SJ - \frac{1}{6} SI - \frac{1}{6} SH \qquad ( 101 )$$

$$\frac{dH}{dx} = 0 = - α {ε}_{ZnO} H - \frac{2}{6} SH + \frac{4}{6} SI + \frac{4}{6} SJ \qquad ( 102 )$$

Now solving eq. 102 for H,

$$H = \frac{\frac{2}{3} SI + \frac{2}{3} SJ}{α {ε}_{ZnO} + \frac{1}{3} S} = \frac{2 I + 2 J}{\frac{3 {αε}_{ZnO}}{S} + 1} = \frac{2}{\frac{3 {αε}_{ZnO}}{S} + 1} I + \frac{2}{\frac{3 {αε}_{ZnO}}{S} + 1} J \qquad ( 103 )$$

Then substituting H from eq 103 into eqs. 100 and 101,

$$\frac{dI}{dx} = - {αε}_{ZnO} I - \frac{5}{6} SI + \frac{1}{6} SJ + \frac{S}{\frac{9 {αε}_{ZnO}}{S}} I + \frac{S}{\frac{9 {αε}_{ZnO}}{S} + 3} J \qquad ( 104 )$$

$$\frac{dJ}{dx} = {αε}_{ZnO} J + \frac{5}{6} SJ - \frac{1}{6} SI - \frac{S}{\frac{9 {αε}_{ZnO}}{S} + 3} I - \frac{S}{\frac{9 {αε}_{ZnO}}{S} + 3} J \qquad ( 105 )$$

Now simplifying eqs. 104 and 105,

$$\frac{dI}{dx} = ( - {αε}_{ZnO} - \frac{5}{6} S + \frac{S}{\frac{9 {αε}_{ZnO}}{S} + 3} ) I + ( \frac{1}{6} S + \frac{S}{\frac{9 {αε}_{ZnO}}{S} + 3} ) J \qquad ( 106 )$$

$$\frac{dJ}{dx} = - ( \frac{1}{6} S + \frac{S}{\frac{9 {αε}_{ZnO}}{S} + 3} ) I + ( {αε}_{ZnO} + \frac{5}{6} S - \frac{S}{\frac{9 {αε}_{ZnO}}{S} + 3} ) J \qquad ( 107 )$$

Normalizing both equations by I₀ and creating a matrix formulation allows rewriting these differential equations as,

$$\frac{d}{dx} ( \begin{matrix}\tilde{I} \\ \tilde{J}\end{matrix} ) = ( \begin{matrix}- {αε}_{ZnO} - \frac{5}{6} S + \frac{S}{\frac{9 {αε}_{ZnO}}{S} + 3} & \frac{1}{6} S + \frac{S}{\frac{9 {αε}_{ZnO}}{S} + 3} \\ - \frac{1}{6} S - \frac{S}{\frac{9 {αε}_{ZnO}}{S} + 3} & {αε}_{ZnO} + \frac{5}{6} S - \frac{S}{\frac{9 {αε}_{ZnO}}{S} + 3}\end{matrix} ) ( \begin{matrix}\tilde{I} \\ \tilde{J}\end{matrix} ) \qquad ( 108 )$$

Hypothesizing a solution of the form,

$$( \begin{matrix}\tilde{I} \\ \tilde{J}\end{matrix} ) = ( \begin{matrix}a \\ b\end{matrix} ) {e}^{λ x} \qquad ( 109 )$$

where a and b are constants. Inserting eq. 109 into 108 gives,

$$λ ( \begin{matrix}a \\ b\end{matrix} ) {e}^{λ x} = ( \begin{matrix}- {αε}_{ZnO} - \frac{5}{6} S + \frac{S}{\frac{9 {αε}_{ZnO}}{S} + 3} & \frac{1}{6} S + \frac{S}{\frac{9 {αε}_{ZnO}}{S} + 3} \\ - \frac{1}{6} S - \frac{S}{\frac{9 {αε}_{ZnO}}{S} + 3} & {αε}_{ZnO} + \frac{5}{6} - \frac{S}{\frac{9 {αε}_{ZnO}}{S} + 3}\end{matrix} ) ( \begin{matrix}a \\ b\end{matrix} ) {e}^{λ x} \qquad ( 110 )$$

which simplifies to,

$$( \begin{matrix}- {αε}_{ZnO} - \frac{5}{6} S + \frac{S}{\frac{9 {αε}_{ZnO}}{S} + 3} & \frac{1}{6} S + \frac{S}{\frac{9 {αε}_{ZnO}}{S} + 3} \\ - \frac{1}{6} S - \frac{S}{\frac{9 {αε}_{ZnO}}{S} + 3} & {αε}_{ZnO} + \frac{5}{6} S - \frac{S}{\frac{9 {αε}_{ZnO}}{S} + 3}\end{matrix} ) ( \begin{matrix}a \\ b\end{matrix} ) = λ ( \begin{matrix}a \\ b\end{matrix} ) \qquad ( 111 )$$

showing it to be an eigenvalue problem. Finding the eigenvalues λ is done by solving the following,

$$det ( ( \begin{matrix}- {αε}_{ZnO} - \frac{5}{6} S + \frac{S}{\frac{9 {αε}_{ZnO}}{S} + 3} & \frac{1}{6} S + \frac{S}{\frac{9 {αε}_{ZnO}}{S} + 3} \\ - \frac{1}{6} S - \frac{S}{\frac{9 {αε}_{ZnO}}{S} + 3} & {αε}_{ZnO} + \frac{5}{6} S - \frac{S}{\frac{9 {αε}_{ZnO}}{S} + 3}\end{matrix} ) -$$

$$λ ( \begin{matrix}1 & 0 \\ 0 & 1\end{matrix} ) ) = 0$$

$$det ( \begin{matrix}- {αε}_{ZnO} - \frac{5}{6} S + \frac{S}{\frac{9 {αε}_{ZnO}}{S} + 3} - λ & \frac{1}{6} S + \frac{S}{\frac{9 {αε}_{ZnO}}{S} + 3} \\ - \frac{1}{6} S - \frac{S}{\frac{9 {αε}_{ZnO}}{S} + 3} & {αε}_{ZnO} + \frac{5}{6} S - \frac{S}{\frac{9 {αε}_{ZnO}}{S} + 3} - λ\end{matrix} ) =$$

$$( - {αε}_{ZnO} - \frac{5}{6} S + \frac{S}{\frac{9 {αε}_{ZnO}}{S} + 3} - λ ) ( {αε}_{ZnO} + \frac{5}{6} S - \frac{S}{\frac{9 {αε}_{ZnO}}{S} + 3} - λ ) -$$

$$( \frac{1}{6} S + \frac{S}{\frac{9 {αε}_{ZnO}}{S} + 3} ) ( - \frac{1}{6} S - \frac{S}{\frac{9 {αε}_{ZnO}}{S} + 3} ) = 0$$

$$λ = \pm ( S + {αε}_{ZnO} ) \sqrt{3 {αε}_{ZnO} / ( S + 3 {αε}_{ZnO} )}$$

White ZnO powder has properties of approximately S=10,000 cm⁻¹ and a=2 cm⁻¹. And the void coefficient is likely approximately 2ZnO=0.75. So, a_{zno}=±212 cm⁻¹, which gives an extinction length of I as 47 μm, so the matrix equation becomes,

$$( \begin{matrix}- {αε}_{ZnO} - \frac{5}{6} S + \frac{S}{\frac{9 {αε}_{ZnO}}{S} + 3} & \frac{1}{6} S + \frac{S}{\frac{9 {αε}_{ZnO}}{S} + 3} \\ - \frac{1}{6} S - \frac{S}{\frac{9 {αε}_{ZnO}}{S} + 3} & {αε}_{ZnO} + \frac{5}{6} S - \frac{S}{\frac{9 {αε}_{ZnO}}{S} + 3}\end{matrix} ) ( \begin{matrix}a \\ b\end{matrix} ) = \pm ( S + {αε}_{ZnO} ) \sqrt{3 {αε}_{ZnO} / ( S + 3 {αε}_{ZnO} )} ( \begin{matrix}a \\ b\end{matrix} )$$

and the first eigenvalue,

λ₁=−(S+αε_{ZnO})\sqrt{3αε_{ZnO}/(S+3αε_{ZnO})}

has an eigenvector that follows the equations,

$$( - {αε}_{ZnO} - \frac{5}{6} S + \frac{S}{\frac{9 {αε}_{ZnO}}{S} + 3} ) a + ( \frac{1}{6} S + \frac{S}{\frac{9 {αε}_{ZnO}}{S} + 3} ) b = - a ( S + {αε}_{ZnO} ) \sqrt{3 {αε}_{ZnO} / ( S + 3 {αε}_{ZnO} )} \\ ( - \frac{1}{6} S - \frac{S}{\frac{9 {αε}_{ZnO}}{S} + 3} ) a + ( {αε}_{ZnO} + \frac{5}{6} S - \frac{S}{\frac{9 {αε}_{ZnO}}{S} + 3} ) b = - b ( S + {αε}_{ZnO} ) \sqrt{3 {αε}_{ZnO} / ( S + 3 {αε}_{ZnO} )} \\ b = \frac{- a ( S + {αε}_{ZnO} ) \sqrt{\frac{3 {αε}_{ZnO}}{( S + 3 {αε}_{ZnO} )}} - a ( - {αε}_{ZnO} - \frac{5}{6} S + \frac{S}{\frac{9 {αε}_{ZnO}}{S} + 3} )}{( \frac{1}{6} S + \frac{S}{\frac{9 {αε}_{ZnO}}{S} + 3} )}$$

The boundary conditions of Ĩ=1 at x=0 means a=1. The second eigenvalue can't be in the final solution, so we skip it. The general solution is therefore,

To calculate a for each wavelength and potential, we assumed S of electroactive ZnO in the colorless state at 1.0 V is equivalent to the literature value of S≈10⁵ cm⁻¹ (Ref. Error! Bookmark not defined.). Solving equation (112) with the above parameters gives the calculation for α found in FIG. 3c in the main text. Uncertainty in the calculation of α comes from the assumptions for S and ε_{ZnO}, which can be assumed to be less than one order of magnitude.

### Example 11

Coloration Efficiency—A 5 mm by 5 mm Zn foil electrolyte was discharged in KOH until a continuous layer of electrochromic ZnO was accumulated. Charge inserted, Q, (FIG. 19) was 0.03 C.

Thickness, t, 50 μm, was calculated using capacity, Q, (0.03 C), ZnO specific capacity (1 mAh/g), density (5.61 g/cm³), and area (0.25 cm²). And coloration efficiency, CE, was calculated from,

$$CE = \frac{{log}_{10} \frac{{T}_{b}}{{T}_{e}}}{\frac{Q}{A}} \\ a = \frac{1}{t} * ln ( \frac{{( \begin{matrix}1 & R\end{matrix} )}^{2}}{T} )$$

Solving for T and substituting into CE gives,
From FIG. 2c, a_{c}>>a_{b}, so

$$CE = \frac{{log}_{10} ( {e}^{{c}^{t}} ) {log}_{10} ( {e}^{{b}^{t}} )}{\frac{Q}{A}} \\ CE = \frac{{log}_{10} ( {e}^{{c}^{t}} )}{\frac{Q}{A}}$$

### Example 12

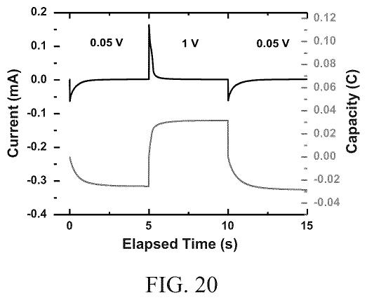

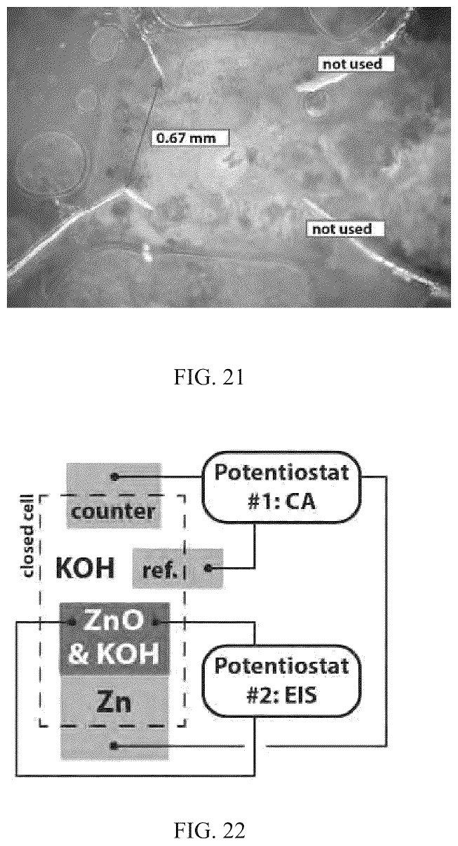

Conductivity Measurements with EIS—Electrochromic ZnO was accumulated in 5.5 M KOH by discharging a 0.25 mm thick Zn metal electrode at 0.2 V with the Versastat 4 potentiostat. The (+) and (−) wires from a Biologic VSP-300 Multipotentiostat were contacted on the ZnO at positions 0.67 mm apart. The EIS signal was imposed/collected between these two points on the ZnO. The overall electrode potential was held constant (at one of seven choices of potential) with a separate potentiostat (a Versastat 4 potentiostat) that was connected to the Zn metal electrode and a reference electrode. While holding the potential constant, the electrochemical impedance spectroscopy (EIS) data was collected from the ZnO material. FIG. 20 shows a photo of the working electrode and EIS connections. Note the electrochromic ZnO is present on the left side of the photo because this side was closest to the counter electrode. The resistance measured at 150 kHz is always −50 n, corresponding to the conductivity of the electrolyte percolating the porous ZnO material. At 1 Hz, the resistance is sensitive to the potential of the ZnO. The EIS configuration is shown in FIG. 21.

A representative circuit consisting of a constant phase element (imperfect capacitive double layer) and a resistor (electrolyte resistance) in parallel with another resistor (ZnO electrical resistance) was used to calculate ZnO resistance.

### Example 13

Raman Spectroscopy—Additional Raman scattering measurements made on electrochromic ZnO generated in KOH and electrochromic ZnO generated in deuterated KOH are found in FIG. 22. The figure shows electrochromic ZnO at 0 V generated in H₂O and D₂O. Three locations were sampled for each environment to demonstrate repeatability.

A few notes about unintuitive LO mode behavior can be made. First, it is not immediately clear why, at 0 V, two “LO modes” exist simultaneously at two different frequencies. This confusion arises mostly from nomenclature, as the LPP− and resonantly enhanced LO mode are both called longitudinal optical phonons, but they arise from two distinct physical phenomena, and their simultaneous existence is not forbidden. Second, at high electron concentrations, one might expect the resonantly enhanced LO mode to take the TO frequency, as observed under non-resonant conditions. However, under resonant conditions, phonons and plasmons uncouple, removing the screening effect by the plasma, allowing the LO mode to take the LO frequency, confirming that our results are not unusual. Third, at low electron concentration under 633 nm excitation (non-resonant conditions), the LPP+ phonon is not observed at the LO frequency. In this case, it can be hypothesized that the plasmon-coupled mode is either too broad or weak to be observed with our experimental setup.

### Example 14

X-Ray Diffraction—Operando X-Ray diffraction was collected at the 5-ID SRX beamline at National Synchrotron Light SourceII at Brookhaven National Laboratory. A cell using a 50-micron thick Zn foil electrode was assembled using acrylic and structural epoxy. Electrochromic ZnO was generated by holding the electrode potential at 0.2 V. Synchrotron XRD of the electrochromic ZnO was taken with a micron-diameter beam at three different locations after generating this layer. Electrode potential was then held at 0.5 V relative to a Zn wire for 14 hours to generate substantial quantities of amber ZnO. An optical microscope was used to locate the amber area on the electrode. XRD was then taken at three different locations in the amber ZnO.

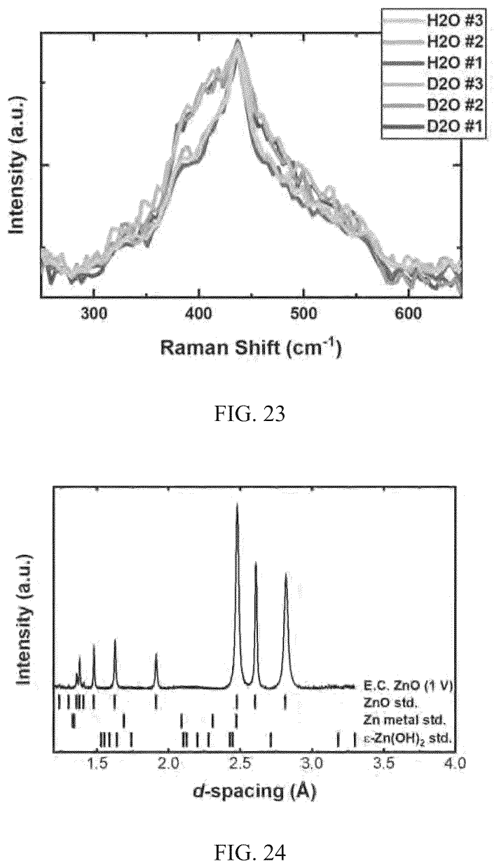

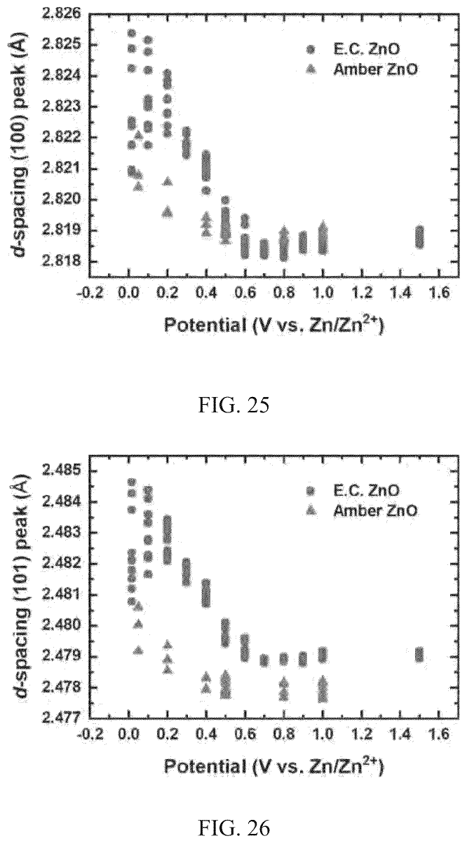

Electrochromic ZnO diffractogram and standard tabulated data for ZnO, Zn metal, and s-Zn(OH)₂ (zinc hydroxide) are found in FIG. 23. Additional d-spacing measurements are found in FIG. 24 and FIG. 25.

### Example 15

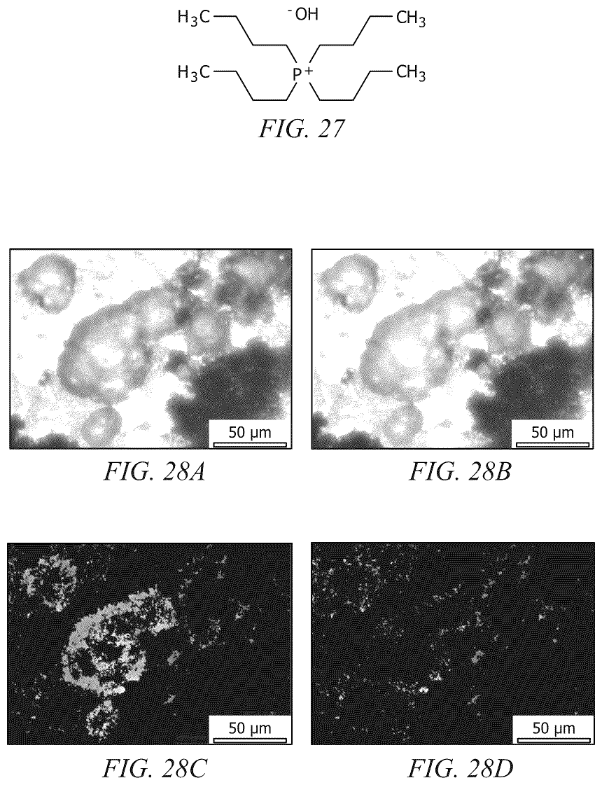

Electrochromism in tetrabutylphosphonium hydroxide—Zn foil was oxidized in 1.4 M tetrabutylphosphonium hydroxide (TBPOH) solution (40 wt. % in H₂O) to generate electrochromic ZnO. After discharging at 0.2 V for approximately 12 hours, blue-colored oxide was observed in isolated areas on the surface of the Zn. Smaller amounts of electrochromic oxide were observed in this electrolyte compared to KOH, likely owing to different solubilities, zincate diffusion coefficients, and precipitation behavior. The oxide changed color from blue at 0.05 V to white at 1 V on the same time scale (˜1 sec) as color change in the ZnO generated in KOH. The tetrabutylphosphonium cation is too large to insert into the ZnO crystal (FIG. 26), and color change is still observed, so alkali metal ions are not necessary for color change. The color difference is not as stark as observed for ZnO generated in KOH. To clearly illustrate the color change, we applied a color mask that shows only blue-colored pixels (FIG. 27).

In the above test, color change was apparent, but not as stark as observed in KOH electrolyte. It is hypothesized that solubility, zincate diffusion coefficient, and precipitation behavior were responsible for the difference in behavior, but performed further tests to establish K⁺ insertion is not required for ZnO coloration, demonstrating that coloration results only from control of oxygen and hydrogen defects.

Electrochromic ZnO was generated via oxidation of Zn foil at 0.2 V. After generation, a 1 cm×3 cm electrochromic ZnO on Zn foil electrode was soaked in a 5 L bath of deionized water for 15 hours to remove free KOH from the electrode. The electrode was removed from the water bath then placed in a 20 mL vial of stirred 1.4 M TBPOH electrolyte. It was cycled three times between 1.0 V and 0.05 V and coloration was recorded with a video. The electrode was finally held at 1.0 V until completely white in color, removing any inserted ions.

The electrochromic ZnO electrode was then transferred to a second 20 mL vial of stirred 1.4 M TBPOH electrolyte, free of K⁺ ions, where cycling was repeated. Color change was again observed and recorded in this new vial of TBPOH, suggesting K⁺ is not required for coloration. The electrode potential was again held at 1.0 V to remove inserted ions and moved to a third 20 mL vial of stirred 1.4 M TBPOH electrolyte. Finally, the electrode was moved to a 20 mL vial of stirred 1.4 M KOH electrolyte, where cycling was repeated, and color change was observed and recorded.

The color-change phenomenon was observed in all four of the vials, and the “blueness” of the ZnO at 0.05 V was the same in each of the vials (Video S5). This establishes K⁺ is not required for coloration. Because coloration is an indicator of an increase in visible absorption, band gap, and conductivity, we establish that only oxygen and hydrogen defects are responsible for the change in ZnO electronic properties. Additional visible light images of coloration of ZnO generated in KOH electrolyte and then cycled in TBPOH electrolyte are found in FIGS. 28A-28D.

### Example 16

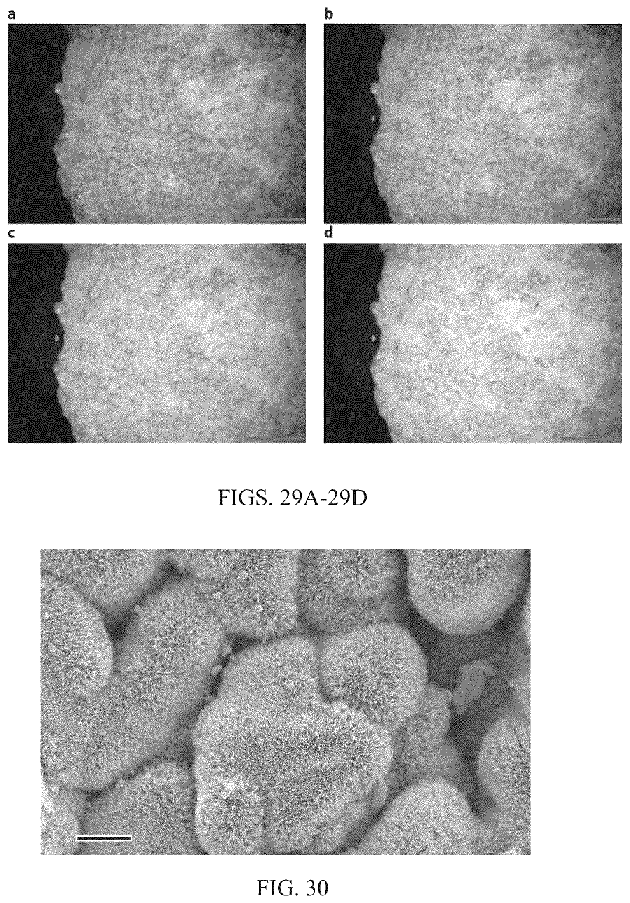

Electron Microscopy Scanning—A Zeiss SUPRA 55-VP SEM was used to obtain SEM images. Samples shown were of Zn foil discharged in 5.5 M KOH until electrochromic ZnO was accumulated. The foil samples were then soaked in deionized water for 24 hours to remove KOH. They were then dried in ambient conditions for 24 hours prior to imaging. The surface of visibly blue ZnO was imaged in FIG. 29 and FIG. 30. The image shows ZnO needles forming in urchin-like structures of approximately 10 microns in diameter. This is consistent with results in the literature that show similar structures of defect-rich ZnO clusters forming via precipitation from NaOH and KOH.

### Example 17

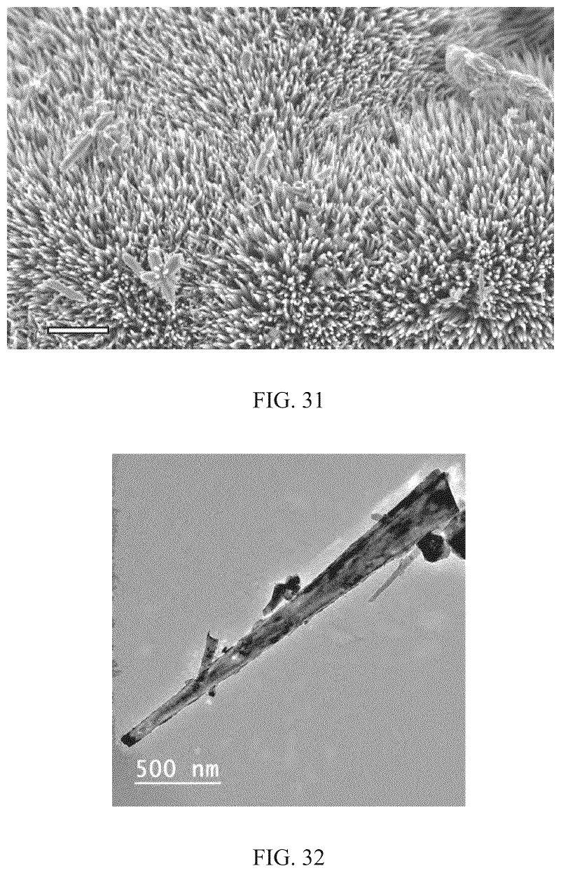

Transmission Electron Microscopy (TEM)—A JEOL 2100 TEM was used to obtain TEM images. Samples shown were of Zn foil discharged in 5.5 M KOH until electrochromic ZnO was accumulated. The foil samples were then soaked in deionized water for 24 hours to remove KOH. They were then dried in ambient conditions for 24 hours prior to imaging. Visibly blue-colored ZnO was scraped off the dried electrode and ground with a mortar and pestle for imaging. TEM was performed on one needle from the urchin structures identified with SEM. See FIG. 31. Lattice spacing was measured on 12 different lattice sites identified in TEM images. Only D-spacing matching peaks associated with the ZnO (101) and (002) reflections were observed as shown in FIG. 32.

### Example 18

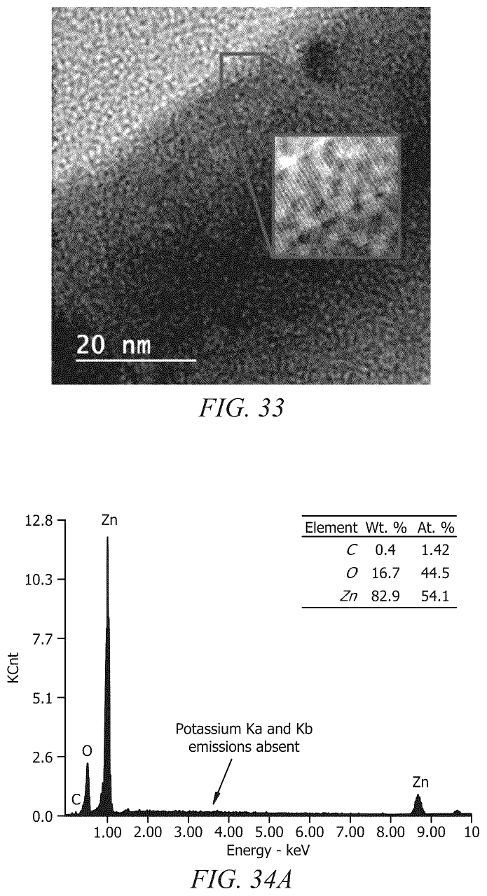

Elemental Measurement—EDS and XPSEnergy-dispersive X-ray Spectroscopy (EDS) —EDS was performed with an Ametek EDAX EDS installed on the Zeiss SUPRA 55-VP SEM on the same sample imaged with the SEM in Example 17 with the images shown in FIG. 33B. Notably, EDS shows no measurement of the potassium Kemissions (FIG. 33A) suggesting the blue electrochromic ZnO is not potassium-doped. See FIG. 33A also for elemental analysis showing Zn:O ratio of approximately 1:1 and an SEM image of location measured on ZnO electrode.

### Example 19

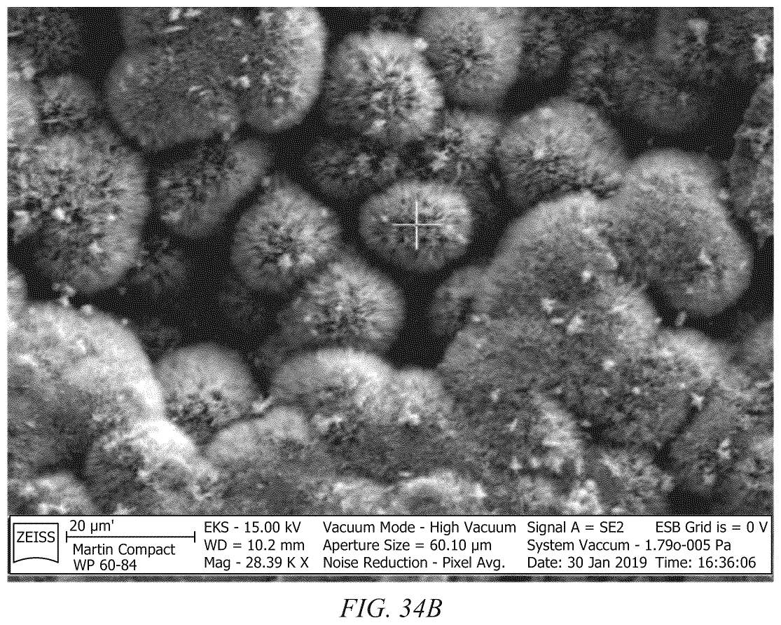

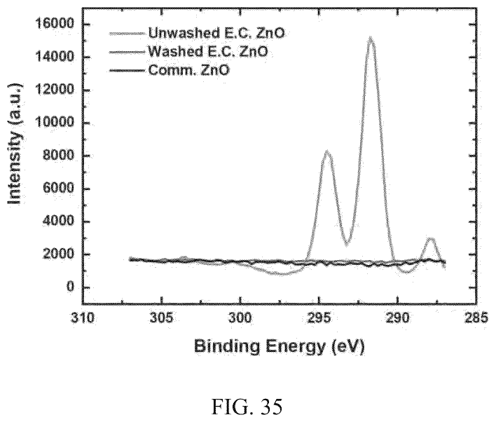

X-ray Photoelectron Spectroscopy (XPS)—XPS was performed with a Physical Electronics Versaprobe II XPS. The 2p electron of potassium (K 2p) was observed on three samples. One sample, “washed electrochromic ZnO”, was the same blue ZnO sample from above, which was prepared by soaking in deionized water to remove residual KOH. Another blue ZnO electrode was prepared, “unwashed electrochromic ZnO”, by generating electrochromic ZnO in the usual way, removing the electrode from the electrolyte, patting it dry, then drying it under vacuum. This method omitted the soaking step and had residual KOH in the electrode. The final sample was commercially purchased ZnO. We observe clear K 2p peaks only for the electrochromic ZnO sample that was not soaked in deionized water (FIG. 34). The soaked and dried electrochromic ZnO and the commercial ZnO samples both showed no K 2p signals suggesting the electrochromic ZnO is not K-doped.

Having described various systems, methods, and examples, certain aspect can include, but are not limited to:

In a first aspect, a system for utilizing zinc oxide comprises: a first electrode comprising a zinc oxide reagent material; a current collector electrically connected to the zinc oxide reagent material, wherein the zinc oxide reagent material is capable of electrochemical intercalation and de-intercalation reactions with an electrolyte, wherein the zinc oxide reagent material comprises a zinc oxide intercalated with electrons, wherein the current collector is configured to provide electrons and voltage control to the zinc oxide reagent material, the electrolyte in contact with the zinc oxide reagent material and capable of executing intercalation reactions with the zinc oxide reagent material; and a second electrode, wherein the second electrode comprises a counter-electrode or a reference electrode electrically coupled to one or more electronics, wherein the electronics are configured to control electrochemical voltage of the current collector and the zinc oxide reagent material.

A second aspect can include the system as recited in the first aspect, wherein the zinc oxide reagent material has a chemical composition provide by the formula: ZnₓO_{y}A_{z}, where A is a compound that enables zinc oxide reactions, wherein Z is equal to or greater than zero, and X and Y are non-zero numbers.

A third aspect can include the system as recited in the second aspect, wherein A is selected from H, Li, Na, K, Cs, Al, In, Mg, Ca, or any combination thereof.

A fourth aspect can include the system as recited in any one of the first to third aspects, wherein the zinc oxide reagent material and the current collector are optically transparent, wherein the zinc oxide reagent material is configured to change transparency or color at different oxidation states, and wherein the system forms a window of controllable transparency or color.

A fifth aspect can include the system as recited in any one of the first to fourth aspects, wherein the first electrode comprises at least one of zinc oxide or zinc metal in a state capable of electro-conversion reactions to produce either zinc metal or zinc oxide, thereby producing electro-conversion zinc or zinc oxide.

A sixth aspect can include the system as recited in the fifth aspect, wherein the morphological microstructure or mixture geometry of the first electrode is made such that intercalation reactions occur simultaneously with electro-conversion reactions.

A seventh aspect can include the system as recited in the fifth or sixth aspect, wherein the morphological microstructure or mixture geometry of the first electrode is made such that intercalation reactions occur faster or slower than electro-conversion reactions.

An eighth aspect can include the system as recited in any one of the fifth to seventh aspects, wherein the chemical composition or microstructure of the zinc oxide is configured to provide reactions at a specific electrochemical voltage.

A ninth aspect can include the system as recited in any one of the first to eighth aspects, further comprising: a sensor configured to detect the oxidation/reduction state of the zinc oxide reagent material, where the sensor is configure to detect at least one of a color of the zinc oxide reagent material or a resistivity of the zinc oxide reagent material.

A tenth aspect can include the system as recited in the ninth aspect, further comprising: a microcontroller in signal communication with the sensor, wherein the microcontroller is configured to receive the oxidation/reduction state of the zine oxide reagent material, and control the electrochemical voltage of the first electrode based on the oxidation/reduction state.

In an eleventh aspect, a method for utilizing zinc oxide comprises: changing an electrochemical voltage of a zinc oxide material that hosts intercalation reactions; and extracting an electrical current from the zinc oxide material as part of a battery operation or a pseudo-capacitor operation.

A twelfth aspect can include the method of the eleventh aspect, wherein changing the electrochemical voltage of the zinc oxide material comprises changing a transparency or a color of the zinc oxide material, wherein the zinc oxide material is part of an optical window formed from the zinc oxide material, and wherein the optical window changes transparency or color in response to changing the transparency or the color of the zinc oxide material.

In a thirteenth aspect, a method for utilizing zinc oxide comprises: extracting information regarding color or conductivity from zinc oxide via a sensor, wherein the zinc oxide is part of an electrode, and wherein the zinc oxide is intercalated with at least one additional element; and controlling an electrochemical voltage of the electrode in a battery or pseudo-capacitor using the information.

A fourteenth aspect can include the method of the thirteenth aspect, further comprising: maintaining the electrochemical voltage of the electrode using the information at a defined potential, wherein the electrochemical voltage is maintained relative to a reference electrode or a counter electrode, and wherein maintaining the electrochemical voltage comprises controlling at least one of a voltage, a current, or a resistance with a controller.

A fifteenth aspect can include the method of the thirteenth or fourteenth aspect, wherein the information comprises a voltage of the electrode, and wherein extracting information comprises extracting information on the conductivity, and wherein the voltage and conductivity satisfy an equation or equations relating the voltage, V, relative to a reference electrode or a counter electrode, to the conductivity, C, of the zinc oxide as: C=aV³+bV²+cV+d, wherein a, b, c, and d are defined variables.

A sixteenth aspect can include the method of the fifteenth aspect, wherein the electrochemical voltage is controlled to maintain C at a defined value.

A seventeenth aspect can include the method of any one of the thirteenth to sixteenth aspects, wherein the information comprises a color value of the color of the electrode, and wherein extracting information comprises extracting information on the conductivity, and wherein the color value and the conductivity satisfy an equation or equations relating the color value, X, to the conductivity, C, of the zinc oxide as: C=aX³+bX²+cX+d, wherein a, b, c, and d are defined variables.

An eighteenth aspect can include the method of any one of the thirteenth to seventeenth aspects, wherein the information comprises a carrier concentration, Y, of the zinc oxide, and wherein extracting information comprises extracting information on the conductivity, C, and wherein the carrier concentration and the conductivity satisfy an equation or equations relating the carrier concentration to the conductivity of the zinc oxide as: C=aY^{b}, where a and b are defined variables.

A nineteenth aspect can include the method of the eighteenth aspect, wherein the electrochemical voltage is controlled to maintain C at a defined value.

A twentieth aspect can include the method of any one of the thirteenth to nineteenth aspects, wherein controlling the electrochemical voltage of the electrode comprises maintaining the electrochemical voltage, relative to a reference electrode or a counter electrode, higher than a minimum defined value by directly controlling a current or a resistance with a controller.

A twenty first aspect can include the method of any one of the thirteenth to twentieth aspects, wherein the information comprises an electrode potential, P, relative to a reference, and wherein extracting information comprises extracting information on a cell voltage, a current, a resistance, a discharge time, and an operating time, and wherein the electrode potential satisfies an equation or equations as: P=a*I*(V−b), or P=a*(V−b*I), wherein I is current, V is the cell voltage, and a and b are defined variables.

In a twenty second aspect, a method for generating intercalation zinc oxide comprises: converting zinc metal to zinc oxide intercalated with at least one additional element to produce a zinc oxide reagent material; and placing the zinc oxide reagent material into a battery.

A twenty third aspect can include the method of the twenty second aspect, wherein converting the zinc metal to zinc oxide comprises: precipitating the zinc oxide reagent material from an alkaline electrolyte using a change in temperature of the alkaline electrolyte.

A twenty fourth aspect can include the method of the twenty second aspect, wherein converting the zinc metal to zinc oxide comprises: precipitating the zinc oxide reagent material from an alkaline electrolyte using a reduction in a concentration of the alkaline electrolyte.

In a twenty fifth aspect, a method for generating intercalation zinc oxide comprises: converting zinc metal to zinc oxide intercalated with an additional element in situ in a device.

A twenty sixth aspect can include the method of the twenty fifth aspect, wherein converting the zinc metal to the zinc oxide comprises electrochemically discharging the zinc metal in situ; and converting the zinc metal to the zinc oxide intercalated with the additional element.

A twenty seventh aspect can include the method of the twenty fifth or twenty sixth aspect, wherein converting the zinc metal occurs using a constant current, a constant voltage, or a constant power to convert the zinc metal to the zinc oxide intercalated with the additional element.

A twenty eighth aspect can include the method of any one of the twenty fifth to twenty seventh aspects, wherein converting the zinc metal comprises: using a constant current or a constant power to convert a first portion of the zinc metal to the zinc oxide intercalated with the additional element; and using a constant voltage to convert a second portion of the zinc metal to the zinc oxide intercalated with the additional element after converting the first portion of the zinc metal to the zinc oxide intercalated with the additional element.

A twenty ninth aspect can include the method of any one of the twenty fifth to twenty eighth aspects, wherein converting the zinc metal comprises maintaining a determined voltage.

A thirtieth aspect can include the method of any one of the twenty fifth to twenty ninth aspects, further comprising: operating the device; extracting information regarding color or conductivity from the zinc oxide intercalated with an additional element via a sensor, wherein the zinc oxide is part of an electrode, and wherein the zinc oxide is intercalated with at least one additional element; and controlling an electrochemical voltage of the electrode in a battery or pseudo-capacitor using the information.

A thirty first aspect can include the method of the thirtieth aspect, wherein the information comprises a voltage of the electrode, and wherein extracting information comprises extracting information on the conductivity, and wherein the voltage and conductivity satisfy an equation or equations relating the voltage, V, relative to a reference electrode or a counter electrode, to the conductivity, C, of the zinc oxide as: C=aV³+bV²+cV+d, wherein a, b, c, and d are defined variables.

A thirty second aspect can include the method of the thirty first aspect, wherein the electrochemical voltage is controlled to maintain C at a defined value.

A thirty third aspect can include the method of any one of the thirtieth to thirty second aspects, wherein the information comprises a color value of the color of the electrode, and wherein extracting information comprises extracting information on the conductivity, and wherein the color value and the conductivity satisfy an equation or equations relating the color value, X, to the conductivity, C, of the zinc oxide as: C=aX³+bX²+cX+d, wherein a, b, c, and d are defined variables.

A thirty fourth aspect can include the method of any one of the thirtieth to thirty third aspects, wherein the information comprises a carrier concentration, Y, of the zinc oxide, and wherein extracting information comprises extracting information on the conductivity, C, and wherein the carrier concentration and the conductivity satisfy an equation or equations relating the carrier concentration to the conductivity of the zinc oxide as: C=aY^{b}, where a and b are defined variables.

A thirty fifth aspect can include the method of the thirty fourth aspect, wherein the electrochemical voltage is controlled to maintain C at a defined value.

A thirty sixth aspect can include the method of any one of the thirtieth to thirty fifth aspects, wherein controlling the electrochemical voltage of the electrode comprises maintaining the electrochemical voltage, relative to a reference electrode or a counter electrode, higher than a minimum defined value by directly controlling a current or a resistance with a controller.

A thirty seventh aspect can include the method of any one of the thirtieth to thirty sixth aspects, wherein the information comprises an electrode potential, P, relative to a reference, and wherein extracting information comprises extracting information on a cell voltage, a current, a resistance, a discharge time, and an operating time, and wherein the electrode potential satisfies an equation or equations as: P=a*I*(V−b) or P=a*(V−b*I), wherein I is current, V is the cell voltage, and a and b are defined variables.

In a thirty eighth aspect, a battery comprises: an anode, wherein the anode comprises a zinc oxide reagent material comprising a zinc oxide intercalated with electrons; a cathode; a separator disposed between the anode and the cathode, wherein the separator comprises at least one ion selective layer; and an electrolyte in fluid communication with the anode, the cathode, and the separator.

A thirty ninth aspect can include the battery of the thirty eighth aspect, wherein the cathode comprises manganese dioxide.

Embodiments are discussed herein with reference to the Figures. However, those skilled in the art will readily appreciate that the detailed description given herein with respect to these figures is for explanatory purposes as the systems and methods extend beyond these limited embodiments. For example, it should be appreciated that those skilled in the art will, in light of the teachings of the present description, recognize a multiplicity of alternate and suitable approaches, depending upon the needs of the particular application, to implement the functionality of any given detail described herein, beyond the particular implementation choices in the following embodiments described and shown. That is, there are numerous modifications and variations that are too numerous to be listed but that all fit within the scope of the present description. Also, singular words should be read as plural and vice versa and masculine as feminine and vice versa, where appropriate, and alternative embodiments do not necessarily imply that the two are mutually exclusive.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims may be formulated in this Application or of any further Application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any Claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new claims may be formulated to such features and/or combinations of such features during the prosecution of the present Application or of any further Application derived therefrom.

1. A system for utilizing zinc oxide, where said system comprises:
a first electrode comprising a zinc oxide reagent material;
a current collector electrically connected to the zinc oxide reagent material,
wherein the zinc oxide reagent material is capable of electrochemical intercalation and de-intercalation reactions with an electrolyte,
wherein the zinc oxide reagent material comprises a zinc oxide intercalated with a compound that enables zinc oxide reactions,
wherein the current collector is configured to provide electrons and voltage control to the zinc oxide reagent material,
the electrolyte in contact with the zinc oxide reagent material and capable of executing intercalation reactions with the zinc oxide reagent material; and
a second electrode, wherein the second electrode comprises a counter-electrode or a reference electrode electrically coupled to one or more electronics, wherein the one or more electronics are configured to control electrochemical voltage of the current collector and the zinc oxide reagent material.

2. The system as recited in claim 1, wherein the zinc oxide reagent material has a chemical composition provide by the formula:
ZnₓO_{y}A_{z}
where A is the compound that enables zinc oxide reactions, wherein Z is equal to or greater than zero, and X and Y are non-zero numbers.

3. The system as recited in claim 2, wherein A is selected from H, Li, Na, K, Cs, Al, In, Mg, Ca, or any combination thereof.

4. The system as recited in claim 1, wherein the zinc oxide reagent material and the current collector are optically transparent, wherein the zinc oxide reagent material is configured to change transparency or color at different oxidation states, and wherein the system forms a window of controllable transparency or color.

5. The system as recited in claim 1, wherein the first electrode comprises at least one of zinc oxide or zinc metal in a state capable of electro-conversion reactions to produce either zinc metal or zinc oxide, thereby producing electro-conversion zinc or zinc oxide.

6. The system as recited in claim 5, wherein the morphological microstructure or mixture geometry of the first electrode is made such that intercalation reactions occur simultaneously with electro-conversion reactions.

7. The system as recited in claim 5, wherein the morphological microstructure or mixture geometry of the first electrode is made such that intercalation reactions occur faster or slower than electro-conversion reactions.

8. The system as recited in claim 5, wherein the chemical composition or microstructure of the zinc oxide is configured to provide reactions at a specific electrochemical voltage.

9. The system of claim 1, further comprising:
a sensor configured to detect the oxidation/reduction state of the zinc oxide reagent material, where the sensor is configured to detect at least one of a color of the zinc oxide reagent material or a resistivity of the zinc oxide reagent material.

10. The system as recited claim 9, further comprising:
a microcontroller in signal communication with the sensor, wherein the microcontroller is configured to receive the oxidation/reduction state of the zine oxide reagent material, and control the electrochemical voltage of the first electrode based on the oxidation/reduction state.

11. A method for utilizing zinc oxide, where said method comprises:
changing an electrochemical voltage of a zinc oxide material that hosts intercalation reactions; and
extracting an electrical current from the zinc oxide material as part of a battery operation or a pseudo-capacitor operation.

12. The method of claim 11, wherein changing the electrochemical voltage of the zinc oxide material comprises changing a transparency or a color of the zinc oxide material, wherein the zinc oxide material is part of an optical window formed from the zinc oxide material, and wherein the optical window changes transparency or color in response to changing the transparency or the color of the zinc oxide material.

13. The method of claim 11, further comprising:
extracting information regarding color or conductivity from the zinc oxide material via a sensor, wherein the zinc oxide material is part of an electrode, and wherein the zinc oxide material is intercalated with at least one additional element; and
controlling an electrochemical voltage of the electrode in a battery or pseudo-capacitor using the information.

14. The method of claim 13, further comprising:
maintaining the electrochemical voltage of the electrode using the information at a defined potential, wherein the electrochemical voltage is maintained relative to a reference electrode or a counter electrode, and wherein maintaining the electrochemical voltage comprises controlling at least one of a voltage, a current, or a resistance with a controller.

15. The method of claim 13, wherein the information comprises a voltage of the electrode, and wherein extracting information comprises extracting information on the conductivity, and wherein the voltage and conductivity satisfy an equation or equations relating the voltage, V, relative to a reference electrode or a counter electrode, to the conductivity, C, of the zinc oxide as:
C=aV³+bV²+cV+d
wherein a, b, c, and d are defined variables.

16. The method of claim 15, wherein the electrochemical voltage is controlled to maintain C at a defined value.

17. The method of claim 13, wherein the information comprises a color value of the color of the electrode, and wherein extracting information comprises extracting information on the conductivity, and wherein the color value and the conductivity satisfy an equation or equations relating the color value, X, to the conductivity, C, of the zinc oxide as:
C=aX³+bX²+cX+d
wherein a, b, c, and d are defined variables.

18. The method of claim 13, wherein the information comprises a carrier concentration, Y, of the zinc oxide, and wherein extracting information comprises extracting information on the conductivity, C, and wherein the carrier concentration and the conductivity satisfy an equation or equations relating the carrier concentration to the conductivity of the zinc oxide as:
C=aY^{b}
where a and b are defined variables.

19. The method of claim 18, wherein the electrochemical voltage is controlled to maintain C at a defined value.

20. The method of claim 13, wherein controlling the electrochemical voltage of the electrode comprises maintaining the electrochemical voltage, relative to a reference electrode or a counter electrode, higher than a minimum defined value by directly controlling a current or a resistance with a controller.

21. The method of claim 13, wherein the information comprises an electrode potential, P, relative to a reference, and wherein extracting information comprises extracting information on a cell voltage, a current, a resistance, a discharge time, and an operating time, and wherein the electrode potential satisfies an equation or equations as:
P=a*I*(V−b), or P=a*(V−b*I)
wherein I is current, V is the cell voltage, and a and b are defined variables.

22. A method for generating intercalation zinc oxide, wherein the method comprises:
converting zinc metal to zinc oxide intercalated with at least one additional element to produce a zinc oxide reagent material; and
using the zinc oxide reagent material in a battery.

23. The method of claim 22, wherein converting the zinc metal to zinc oxide comprises at least one of:
precipitating the zinc oxide reagent material from an alkaline electrolyte using a change in temperature of the alkaline electrolyte; or
precipitating the zinc oxide reagent material from an alkaline electrolyte using a reduction in a concentration of the alkaline electrolyte.

24. (canceled)

25. The method of claim 22, wherein converting the zinc metal to the zinc oxide occurs in situ in a device, or wherein converting the zinc metal to the zinc oxide occurs outside a device and the zinc oxide is placed into a battery.

26. The method of claim 25, wherein converting the zinc metal to the zinc oxide comprises electrochemically discharging the zinc metal in situ; and
converting the zinc metal to the zinc oxide intercalated with the additional element.

27. The method of claim 25, wherein converting the zinc metal occurs in situ using a constant current, a constant voltage, or a constant power to convert the zinc metal to the zinc oxide intercalated with the additional element.

28. The method of claim 25, wherein converting the zinc metal in situ comprises:
using a constant current or a constant power to convert a first portion of the zinc metal to the zinc oxide intercalated with the additional element; and
using a constant voltage to convert a second portion of the zinc metal to the zinc oxide intercalated with the additional element after converting the first portion of the zinc metal to the zinc oxide intercalated with the additional element.

29. The method of claim 25, wherein converting the zinc metal in situ comprises maintaining a determined voltage.

30. The method of claim 25, further comprising:
operating the device;
extracting information regarding color or conductivity from the zinc oxide intercalated with an additional element via a sensor, wherein the zinc oxide is part of an electrode, and wherein the zinc oxide is intercalated with at least one additional element; and
controlling an electrochemical voltage of the electrode in a battery or pseudo-capacitor using the information.

31. The method of claim 30, wherein the information comprises a voltage of the electrode, and wherein extracting information comprises extracting information on the conductivity, and wherein the voltage and conductivity satisfy an equation or equations relating the voltage, V, relative to a reference electrode or a counter electrode, to the conductivity, C, of the zinc oxide as:
C=aV³+bV²+cV+d
wherein a, b, c, and d are defined variables.

32. The method of claim 31, wherein the electrochemical voltage is controlled to maintain C at a defined value.

33. The method of claim 30, wherein the information comprises a color value of the color of the electrode, and wherein extracting information comprises extracting information on the conductivity, and wherein the color value and the conductivity satisfy an equation or equations relating the color value, X, to the conductivity, C, of the zinc oxide as:
C=aX³+bX²+cX+d
wherein a, b, c, and d are defined variables.

34. The method of claim 30, wherein the information comprises a carrier concentration, Y, of the zinc oxide, and wherein extracting information comprises extracting information on the conductivity, C, and wherein the carrier concentration and the conductivity satisfy an equation or equations relating the carrier concentration to the conductivity of the zinc oxide as:
C=aY^{b}
where a and b are defined variables.

35. The method of claim 34, wherein the electrochemical voltage is controlled to maintain C at a defined value.

36. The method of claim 30, wherein controlling the electrochemical voltage of the electrode comprises maintaining the electrochemical voltage, relative to a reference electrode or a counter electrode, higher than a minimum defined value by directly controlling a current or a resistance with a controller.

37. The method of claim 30, wherein the information comprises an electrode potential, P, relative to a reference, and wherein extracting information comprises extracting information on a cell voltage, a current, a resistance, a discharge time, and an operating time, and wherein the electrode potential satisfies an equation or equations as:
P=a*I*(V−b) or P=a*(V−b*I)
wherein I is current, V is the cell voltage, and a and b are defined variables.

38.-39. (canceled)
